(19) United States
(12) Patent Application Publication
(10) Pub. No.: US 2025/0241303 A1
(43) Pub. Date: Jul. 31, 2025

(54) COMPOSITIONS AND METHODS FOR PROTECTING AND SUPPORTING PLANTS AND SEEDS

(71) Applicant: BEDOUKIAN RESEARCH, INC., Danbury, CT (US)

(72) Inventors: Rodrigo Oliveria da Silva, Bethel, CT (US); David Zareh Bedoukian, Danbury, CT (US)

(21) Appl. No.: 19/078,578

(22) Filed: Mar. 13, 2025

Related U.S. Application Data
(63) Continuation-in-part of application No. 18/769,579, filed on Jul. 11, 2024.
(60) Provisional application No. 63/538,144, filed on Sep. 13, 2023.

(51) Int. Cl. A01N 37/10; A01N 31/04; A01N 31/06; A01N 35/06; A01N 37/18; A01N 43/08; A01N 43/16; A01P 21/00; C05G 1/00

(52) U.S. Cl. CPC A01N 37/10; A01N 31/04; A01N 31/06; A01N 35/06; A01N 37/18; A01N 43/08; A01N 43/16; A01P 21/00; C05G 1/00

(57) ABSTRACT

A method of protecting a plant or seed from stress injury resulting from an environmental stress; and for supporting one or more natural plant or seed processes, or for supporting plant or seed nutrition, or a combination thereof; is disclosed. The method involves applying to at least a portion of the plant or seed a composition having one or more compounds represented by structure (A); and one or more biostimulants, or one or more fertilizers, or a combination thereof; described herein. Compositions useful for protecting a plant or seed from stress injury resulting from an environmental stress; and for supporting one or more natural plant or seed processes, or for supporting plant or seed nutrition, or a combination thereof; are also disclosed. The compositions have one or more compounds represented by structure (A); and one or more biostimulants, or one or more fertilizers, or a combination thereof; described herein. A method of inducing tolerance in a plant or seed to an environmental stress; and supporting one or more natural plant or seed processes, or supporting plant or seed nutrition, or a combination thereof; is disclosed. The method involves applying to at least a portion of the plant or seed a composition comprising one or more compounds represented by structure (A); and one or more biostimulants, or one or more fertilizers, or a combination thereof; described herein. Compositions useful for inducing tolerance in a plant or seed to an environmental stress; and supporting one or more natural plant or seed processes, or supporting plant or seed nutrition, or a combination thereof; are also disclosed. The compositions have one or more compounds represented by structure (A); and one or more biostimulants, or one or more fertilizers, or a combination thereof; described herein.

### RELATED APPLICATION

This application is a continuation-in-part of copending U.S. application Ser. No. 18/769,579, filed Jul. 11, 2024, which claims the benefit of U.S. Application No. 63/538,144, filed Sep. 13, 2023, which are incorporated herein by reference in their entirety.

### BACKGROUND OF THE DISCLOSURE

### 1. Field of the Disclosure

This disclosure relates to methods for protecting a plant or seed from stress injury resulting from an environmental stress, or for inducing tolerance in a plant or seed to an environmental stress; and supporting one or more natural plant or seed processes, or supporting plant or seed nutrition, or a combination thereof. This disclosure also relates to compositions useful for protecting a plant or seed from stress injury resulting from an environmental stress, or for inducing tolerance in a plant or seed to an environmental stress; and supporting one or more natural plant or seed processes, or supporting plant or seed nutrition, or a combination thereof.

### 2. Description of the Related Art

Environmental stresses arise from conditions that are unfavorable for the optimal growth and development of plants or seeds. Environmental stresses can be classified either as abiotic or biotic. Abiotic stresses are produced by inappropriate levels of physical components of the environment such as temperature extremes (high, low, and freezing temperatures), drought/water deficit, flooding, lack of oxygen, salinity, low light, excess light, UV radiation, or oxidative stresses. Biotic stresses include pests such as predators, parasites, insects, arachnids, nematodes, and pathogens such as bacteria, viruses, fungi and mycoplasms.

Plants and seeds are always under constant threat from both biotic and abiotic stresses. The abiotic and biotic stresses are major limiting factors of plant and seed growth and productivity. Crop losses and crop yield losses of major crops such as rice, maize (corn) and wheat caused by these stresses represent a significant economic and political factor and contribute to food shortages in many countries.

Each year these environmental stresses result in billions of dollars worth of vegetative loss resulting from damaged or reduced crop production. Thus, controlling the adverse effects of such environmental stresses on valued plants and crops is both an economic and environmental concern.

The ability of plants to survive from unfavorable conditions is a function of basal and induced tolerance mechanisms. Basal and induced stress tolerance results from complex processes involving several physiological and biochemical changes including, for example, changes in membrane structure and function, tissue water content, protein, lipid, and primary and secondary metabolite composition.

There is a need for controlling the adverse effects of environmental stresses on valued plants and crops. In particular, there is a need for a safe and effective method for protecting plants and seeds from stress injury resulting from abiotic and biotic stresses, thereby enabling optimal growth and development of plants or seeds.

The present disclosure provides many advantages, which shall become apparent as described below.

### SUMMARY OF THE DISCLOSURE

This disclosure relates to methods for protecting a plant or seed from stress injury resulting from an environmental stress, or for inducing tolerance in a plant or seed to an environmental stress; and supporting one or more natural plant or seed processes with biostimulants, or supporting plant or seed nutrition with fertilizers, or a combination thereof. This disclosure also relates to compositions useful for protecting a plant or seed from stress injury resulting from an environmental stress, or for inducing tolerance in a plant or seed to an environmental stress; and supporting one or more natural plant or seed processes with biostimulants, or supporting plant or seed nutrition with fertilizers, or a combination thereof.

This disclosure relates, in part, to a method of protecting a plant or seed from stress injury resulting from an environmental stress; and supporting one or more natural plant or seed processes, or supporting plant or seed nutrition, or a combination thereof. The method involves applying to at least a portion of said plant or seed a composition comprising: i) one or more compounds represented by structure (A); and ii) one or more biostimulants, or one or more fertilizers, or a combination thereof. The one or more compounds are represented by structure (A):

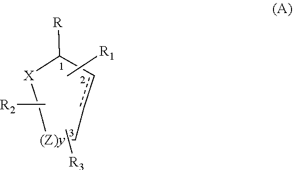

wherein: R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms; X is 0 or CH₂, with the proviso that when X is O, R can only be ═O; each Z is independently selected from (CH) and (CH₂); y is a numeral selected from 1 and 2; R₁ is selected from H or a branched or straight chain, saturated or unsaturated, hydrocarbyl group with zero to two double bonds and from about 1 to about 15 carbon atoms; R₂ is selected from H and a branched or straight chain, saturated or unsaturated, hydrocarbyl group with zero to three double bonds and from about 1 to about 15 carbon atoms; R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12; the bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in a protective amount sufficient to elicit a protective response in the plant or seed to the environmental stress; and when present, the one or more biostimulants are present in the composition in an amount sufficient to support one or more natural plant or seed processes; and, when present, the one or more fertilizers are present in the composition in an amount sufficient to support plant or seed nutrition.

This disclosure also relates, in part, to a method of inducing tolerance in a plant or seed to an environmental stress; and supporting one or more natural plant or seed processes, or supporting plant or seed nutrition, or a combination thereof The method involves applying to at least a portion of said plant or seed a composition comprising: i) one or more compounds represented by structure (A); and ii) one or more biostimulants, or one or more fertilizers, or a combination thereof. The one or more compounds are represented by structure (A):

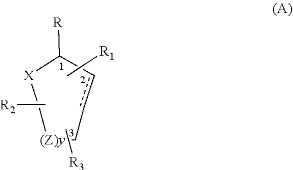

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in an effective amount sufficient to induce tolerance in the plant or seed to the environmental stress; and when present, the one or more biostimulants are present in the composition in an amount sufficient to support one or more natural plant or seed processes; and, when present, the one or more fertilizers are present in the composition in an amount sufficient to support plant or seed nutrition.

This disclosure further relates, in part, to a composition for protecting a plant or seed from stress injury resulting from an environmental stress; and supporting one or more natural plant or seed processes, or supporting plant or seed nutrition, or a combination thereof. The composition includes: i) one or more compounds represented by structure (A); and ii) one or more biostimulants, or one or more fertilizers, or a combination thereof. The one or more compounds are represented by structure (A):

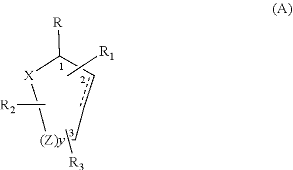

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in a protective amount sufficient to elicit a protective response in the plant or seed to the environmental stress; and when present, the one or more biostimulants are present in the composition in an amount sufficient to support one or more natural plant or seed processes; and, when present, the one or more fertilizers are present in the composition in an amount sufficient to support plant or seed nutrition.

This disclosure yet further relates, in part, to a composition for inducing tolerance in a plant or seed to an environmental stress; and supporting one or more natural plant or seed processes, or supporting plant or seed nutrition, or a combination thereof. The composition includes: i) one or more compounds represented by structure (A); and ii) one or more biostimulants, or one or more fertilizers, or a combination thereof. The one or more compounds are represented by structure (A):

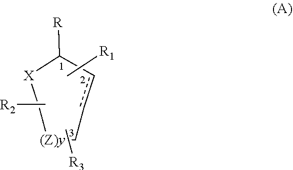

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in an effective amount sufficient to induce tolerance in the plant or seed to the environmental stress; and when present, the one or more biostimulants are present in the synergistic composition in an amount sufficient to support one or more natural plant or seed processes; and, when present, the one or more fertilizers are present in the synergistic composition in an amount sufficient to support plant or seed nutrition.

This disclosure also relates, in part, to a method of protecting a plant or seed from stress injury resulting from an environmental stress; and supporting one or more natural plant or seed processes, or supporting plant or seed nutrition, or a combination thereof. The method involves applying to at least a portion of said plant or seed a synergistic composition comprising: i) one or more compounds represented by structure (A); and ii) one or more biostimulants, or one or more fertilizers, or a combination thereof. The one or more compounds are represented by structure (A):

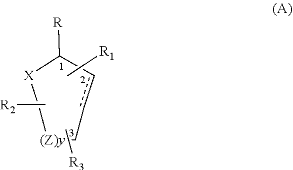

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds of structure (A) are present in the synergistic composition in a protective amount sufficient to elicit a protective response in the plant or seed to the environmental stress; and when present, the one or more biostimulants are present in the synergistic composition in an amount sufficient to support one or more natural plant or seed processes; and, when present, the one or more fertilizers are present in the synergistic composition in an amount sufficient to support plant or seed nutrition. The synergistic combination having a combination of one or more compounds of structure (A); and one or more biostimulants, or one or more fertilizers, or a combination thereof; produces, when the plant or seed is treated with the synergistic composition, a combined protection or supporting effect, greater than the sum of the separate protection or supporting effects, at essentially the same concentrations.

This disclosure further relates, in part, to a synergistic composition for protecting a plant or seed from stress injury resulting from an environmental stress; and supporting one or more natural plant or seed processes, or supporting plant or seed nutrition, or a combination thereof. The synergistic composition includes: i) one or more compounds represented by structure (A); and ii) one or more biostimulants, or one or more fertilizers, or a combination thereof. The one or more compounds are represented by structure (A):

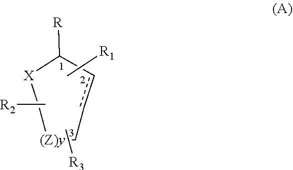

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds of structure (A) are present in the synergistic composition in a protective amount sufficient to elicit a protective response in the plant or seed to the environmental stress; and when present, the one or more biostimulants are present in the synergistic composition in an amount sufficient to support one or more natural plant or seed processes; and, when present, the one or more fertilizers are present in the synergistic composition in an amount sufficient to support plant or seed nutrition. The synergistic combination comprising a combination of one or more compounds of structure (A) produces, when the plant or seed is treated with the synergistic composition, a combined protection or supporting effect, greater than the sum of the separate protection or supporting effects, at essentially the same concentrations.

This disclosure yet further relates, in part, to a method for inducing tolerance in a plant or seed to an environmental stress; and supporting one or more natural plant or seed processes, or supporting plant or seed nutrition, or a combination thereof. The method involves applying to at least a portion of said plant or seed a synergistic composition comprising: i) one or more compounds represented by structure (A); and ii) one or more biostimulants, or one or more fertilizers, or a combination thereof. The one or more compounds are represented by structure (A):

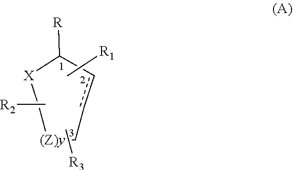

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds of structure (A) are present in the synergistic composition in an effective amount sufficient to induce tolerance in the plant or seed to the environmental stress; and when present, the one or more biostimulants are present in the synergistic composition in an amount sufficient to support one or more natural plant or seed processes; and, when present, the one or more fertilizers are present in the synergistic composition in an amount sufficient to support plant or seed nutrition. The synergistic combination comprising a combination of one or more compounds of structure (A) produces, when the plant or seed is treated with the synergistic composition, a combined protection or supporting effect, greater than the sum of the separate protection or supporting effects, at essentially the same concentrations.

This disclosure also relates, in part, to a synergistic composition for inducing tolerance in a plant or seed to an environmental stress; and supporting one or more natural plant or seed processes, or supporting plant or seed nutrition, or a combination thereof. The synergistic composition includes: i) one or more compounds represented by structure (A); and ii) one or more biostimulants, or one or more fertilizers, or a combination thereof. The one or more compounds are represented by structure (A):

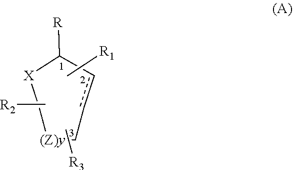

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds of structure (A) are present in the synergistic composition in an effective amount sufficient to induce tolerance in the plant or seed to the environmental stress; and when present, the one or more biostimulants are present in the synergistic composition in an amount sufficient to support one or more natural plant or seed processes; and, when present, the one or more fertilizers are present in the synergistic composition in an amount sufficient to support plant or seed nutrition. The synergistic combination comprising a combination of one or more compounds of structure (A) produces, when the plant or seed is treated with the synergistic composition, a combined protection or supporting effect, greater than the sum of the separate protection or supporting effects, at essentially the same concentrations.

This disclosure also relates, in part, to a method of seed treatment; and supporting one or more natural seed processes, or supporting seed nutrition, or a combination thereof. The method comprises applying to at least a portion of said seed a composition comprising: i) one or more compounds represented by structure (A); and ii) one or more biostimulants, or one or more fertilizers, or a combination thereof. The one or more compounds are represented by structure (A):

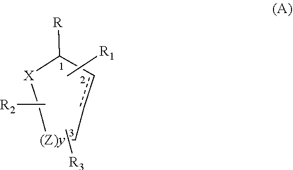

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds represented by structure (A) are present in the composition in an effective amount sufficient to improve a germination characteristic of the seed, as compared to the same germination characteristic of an untreated seed; and when present, the one or more biostimulants are present in the composition in an amount sufficient to support one or more natural plant or seed processes; and, when present, the one or more fertilizers are present in the composition in an amount sufficient to support plant or seed nutrition.

This disclosure further relates, in part, to a method of seed treatment; and supporting one or more natural seed processes, or supporting seed nutrition, or a combination thereof. The method comprises applying to at least a portion of the seed a synergistic composition comprising: i) one or more compounds represented by structure (A); and ii) one or more biostimulants, or one or more fertilizers, or a combination thereof. The one or more compounds are represented by structure (A):

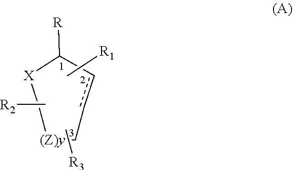

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds of structure (A) are present in the synergistic composition in an amount sufficient to effect a germination characteristic of the seed; and when present, the one or more biostimulants are present in the synergistic composition in an amount sufficient to support one or more natural plant or seed processes; and, when present, the one or more fertilizers are present in the synergistic composition in an amount sufficient to support plant or seed nutrition. The synergistic combination comprising a combination of one or more compounds of structure (A) produces, when the seed is treated with the synergistic composition, a combined germination characteristic effect or supporting effect, greater than the sum of the separate germination characteristic effects or supporting effects, at essentially the same concentrations.

This disclosure yet further relates, in part, to a synergistic composition for improving a germination characteristic of a seed; and supporting one or more natural seed processes, or supporting seed nutrition, or a combination thereof. The synergistic composition comprises: i) one or more compounds represented by structure (A); and ii) one or more biostimulants, or one or more fertilizers, or a combination thereof. The one or more compounds are represented by structure (A):

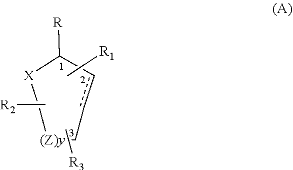

wherein R, X, Z, y, R₁, R₂, and R₃ are as defined hereinabove. The bond between the 2 and 3 positions in the ring structure may be a single or a double bond. The one or more compounds represented by structure (A) contain from about 9 to about 20 carbon atoms, and includes optical isomers, diastereomers and enantiomers of the one or more compounds represented by structure (A). The one or more compounds of structure (A) are present in the synergistic composition in an amount sufficient to effect a germination characteristic of the seed; and when present, the one or more biostimulants are present in the synergistic composition in an amount sufficient to support one or more natural plant or seed processes; and, when present, the one or more fertilizers are present in the synergistic composition in an amount sufficient to support plant or seed nutrition. The synergistic combination comprising a combination of one or more compounds of structure (A) produces, when the seed is treated with the synergistic composition, a combined germination characteristic effect or supporting effect, greater than the sum of the separate germination characteristic effects or supporting effects, at essentially the same concentrations.

This disclosure also includes optical isomers, diastereomers and enantiomers of the named structures. Thus, at all stereocenters where stereochemistry is not explicitly defined, all possible epimers are envisioned.

Further objects, features and advantages of the present disclosure will be understood by reference to the following detailed description.

### DESCRIPTION OF THE EMBODIMENTS

In accordance with this disclosure, methods are provided for protecting a plant or seed from stress injury resulting from an environmental stress; and supporting one or more natural plant or seed processes, or supporting plant or seed nutrition, or a combination thereof. Methods are also provided for inducing tolerance in a plant or seed to an environmental stress; and supporting one or more natural plant or seed processes, or supporting plant or seed nutrition, or a combination thereof. Also, in accordance with this disclosure, compositions are provided that are useful for protecting a plant or seed from stress injury resulting from an environmental stress; and supporting one or more natural plant or seed processes, or supporting plant or seed nutrition, or a combination thereof. Compositions are also provided for inducing tolerance in a plant or seed to an environmental stress; and supporting one or more natural plant or seed processes, or supporting plant or seed nutrition, or a combination thereof.

The methods and compositions of this disclosure provide enhanced protection for plants and seeds from stress injury resulting from environmental stresses, including enhanced resistance to low temperature/cold stress, freezing stress, high temperature/heat stress, salt/salinity stress, low (shading stress) or excessive light (ultraviolet (UV) radiation and other cosmic radiation), oxidative stress, heavy metal stress, lack of oxygen conditions, flooding, drought/water deficit, viral, fungal and bacterial pathogens and/or combinations thereof. In addition, the methods and compositions of this disclosure support one or more natural plant or seed processes, or support plant or seed nutrition, or a combination thereof.

In accordance with this disclosure, there is provided a method which includes contacting at least one plant or seed, or soil around at least one plant or seed, or at least a part of a plant or seed with a composition of this disclosure. The method improves plant or seed growth, health and protects the plant and seed from stress injury resulting from environmental stresses; and supports one or more natural plant or seed processes, or supports plant or seed nutrition, or a combination thereof; or induces plant or seed abiotic and biotic stress tolerance to one or more abiotic or biotic stresses to which the plant or seed is exposed; and supports one or more natural plant or seed processes, or supports plant or seed nutrition, or a combination thereof.

As used herein, the term “abiotic stress” refers to those non-living substances or environmental factors which can cause one or more injuries to a plant. Examples of abiotic stresses include those injuries which result from chilling, freezing, hail, flooding, drought, soil compaction, soil crusting and agricultural chemicals such as pesticides and herbicides. For seeds, rapid rehydration during the initial phase of seed germination is considered to be an abiotic stress. Abiotic stresses are produced by inappropriate levels of physical components of the environment such as temperature extremes (high, low, and freezing temperatures), drought/water deficit, flooding, lack of oxygen, salinity, low light, excess light, UV radiation, or oxidative stresses.

As used herein, the term “biotic stress” refers to those living substances which cause one or more injuries to a plant. Examples of biotic stresses include those injuries resulting from infections by insects, nematodes, snails, mites, weeds, pathogens, such as fungus, bacteria or viruses, and physical damage caused by people and animals (i.e., grazing, tredding, etc.). Biotic stresses include pests such as predators, parasites, insects, arachnids, nematodes, and pathogens such as bacteria, viruses, fungi and mycoplasms.

As used herein, the term “environmental stress” refers to a biotic stress or an abiotic stress.

As used herein, the term “stress injury” refers to an injury resulting from an abiotic stress and/or a biotic stress. Examples of abiotic stress injuries include those injuries resulting from temperature extremes (high, low, and freezing temperatures), drought/water deficit, flooding, lack of oxygen, salinity, low light, excess light, UV radiation, or oxidative stresses. Examples of biotic stress injuries include those injuries resulting from infections by insects, nematodes, snails, mites, weeds, pathogens, such as fungus, bacteria, or viruses. Examples of stress injuries include plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, reduced seedling vigor, and the like.

As used herein, the term “plant” refers to a whole live plant as well as to any part, tissue or organ from a live plant. For example, the term “plant” includes fruit, flowers, tubers, roots, stems, hypocotyls, leaves, petioles, petals, seeds, etc. The plants can be planted in the terra firma, such as a field, garden, orchard, etc., or can be in a pot or other confined growing apparatus (such as a window box, etc.).

As used herein, the term “seed’ refers to any undeveloped plant embryo and food reserve enclosed in a protective outer covering called a seed coat. Seed refers to anything that can be sown, which can include seed and husk or tuber.

As used herein, the term “germination rate” refers to the percentage of seeds that germinate from a group of seeds that are planted or otherwise placed in conditions that promote germination. The terms “speed of germination” and “faster germination,” as used here, refer to the time span over which a radicle emerges.

In accordance with this disclosure, germination may be considered to be complete once a radicle has emerged, and may also be considered to include aspects of early seedling development, such as radicle length. The phrase “germination characteristic(s)” is meant to encompass germination rate and speed of germination per se, as well as effects on early seedling development that are caused or mediated by exposure to the one or more compounds represented by structure (A) herein. Moreover, the phrase “prior to radicle emergence,” is used to mean that the seeds may either be entirely non-germinated or at some perceptible or imperceptible early stage of the germination process. Some signs of germination, like seed swelling, are easily perceptible, while others are not. The phrase “after radicle emergence,” means perceptible emergence of the embryonic root of the plant from the plumule.

As used herein, the term “biostimulant” refers to substances and/or microorganisms whose function, when applied to seeds, plants or the rhizosphere, is to stimulate natural processes to enhance/benefit nutrient uptake, nutrient efficiency, tolerance to abiotic stress, crop quality and/or yield.

As used herein, the term “fertilizer” refers to any material of natural or synthetic origin that is applied to plant tissues or to soil to supply plant or seed nutrients. As used herein, fertilizers are distinct from biostimulants. Fertilizers provide macro- and micro-nutrients, whereas biostimulants stimulate natural plant or seed processes to enhance/benefit nutrient uptake, nutrient efficiency, tolerance to abiotic stress, crop quality and/or yield. As used herein, fertilizers include plant and seed nutrients, and plant and seed growth components.

### Active Ingredients

### Compounds Represented by the Structure (A)

The active ingredients in the compositions of this disclosure include one or more compounds represented by the structure (A):

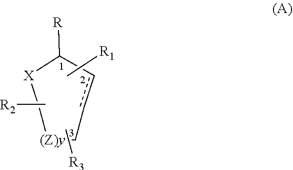

wherein R, X, Z, y, R₁, R₂, and R₃ are as defined hereinabove. The one or more compounds represented by structure (A) are present in the composition in a protective amount sufficient to elicit a protective response in the plant or seed, or in an effective amount sufficient to induce tolerance in a plant or seed to an environmental stress.

In an embodiment, a group of compounds represented by structure (A) are those wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

In an embodiment, a group of compounds represented by structure (A) are those wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₃ is an alkyl or alkenyl group containing at least 3 carbon atoms.

In an embodiment, a group of compounds represented by structure (A) are those wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

In an embodiment, a group of compounds represented by structure (A) include methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), methyl apritone (cyclopentanone, 2-(3,7-dimethyl-2,6-nonadien-1-yl)-), delta-dodecalactone, gamma-dodecalactone, gamma-undecalactone, gamma methyl dodecalactone, gamma-tridecalactone, gamma methyl tridecalactone, gamma-tetradecalactone, 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, and 3-methyl-5-heptyl-2-cyclohexenone.

Representative examples of compounds of structure (A) include, but are not limited to,

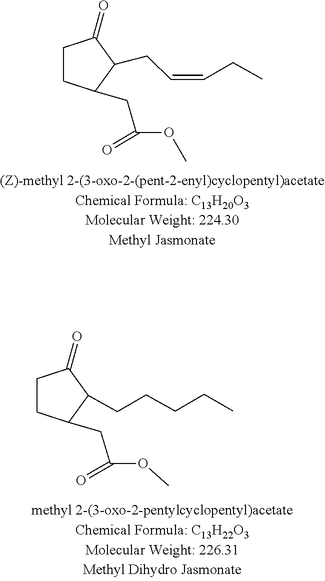 [SMILES: CC/C=C\CC1C(=O)CCC1CC(=O)OC ; CCCCCC1C(=O)CCC1CC(=O)OC]

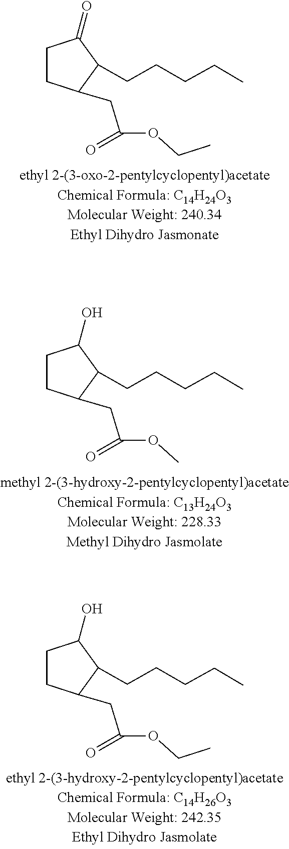 [SMILES: CCCCCC1C(=O)CCC1CC(=O)OCC ; CCCCCC1C(O)CCC1CC(=O)OC ; CCCCCC1C(O)CCC1CC(=O)OCC]

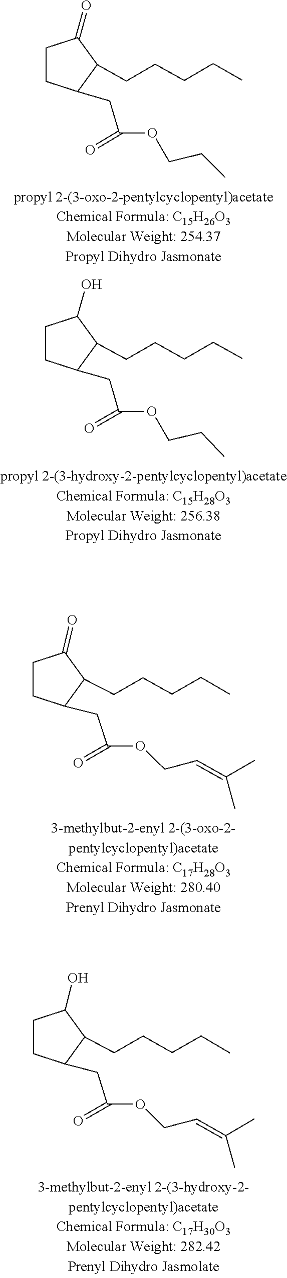 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

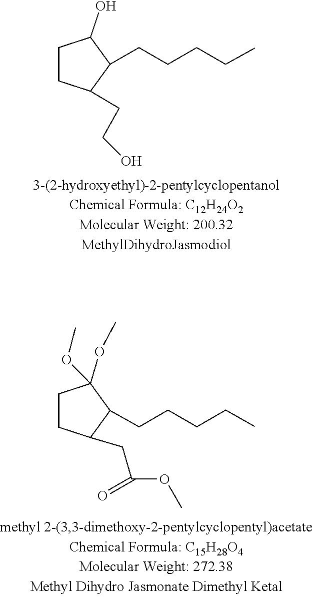 [SMILES: CCCCCC1C(O)CCC1CCO ; CCCCCC1C(CC(=O)OC)CCC1(OC)OC]

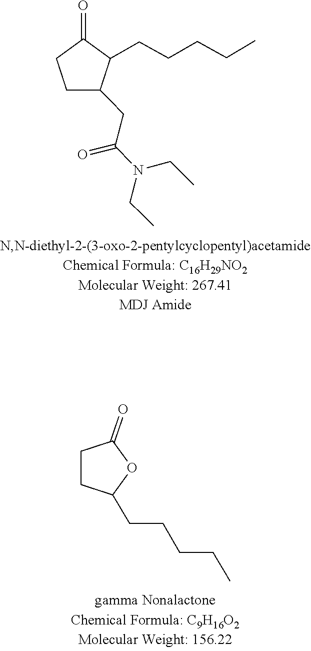 [SMILES: CCCCCC1C(=O)CCC1CC(=O)N(CC)CC ; CCCCCC1CCC(=O)O1]

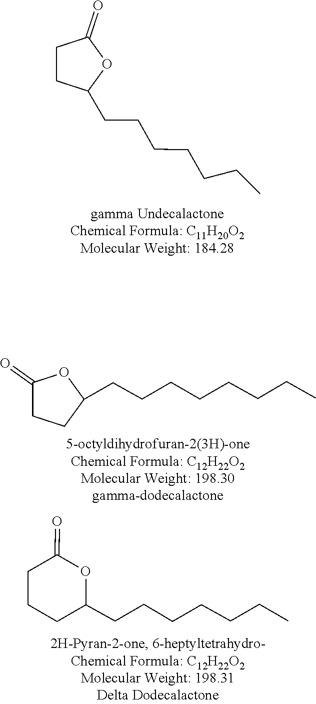

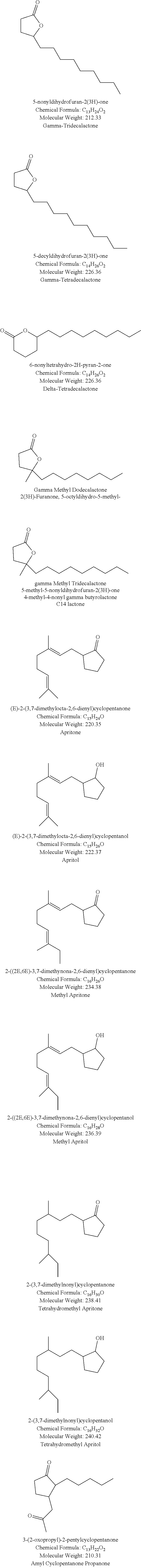

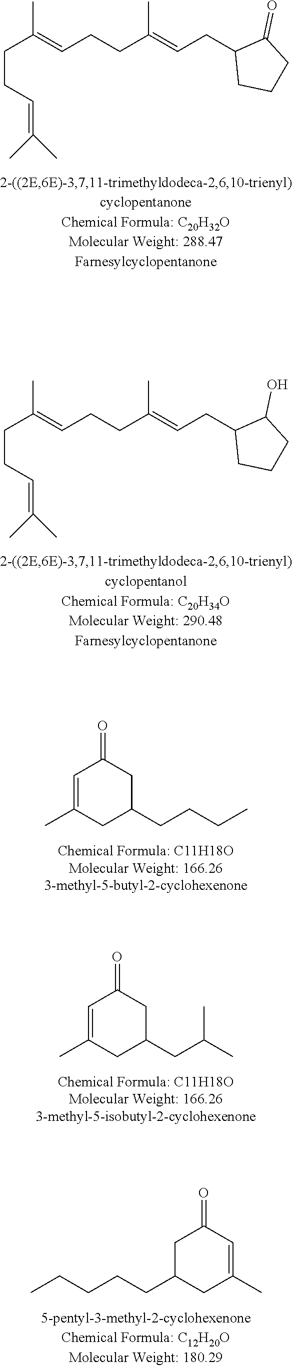

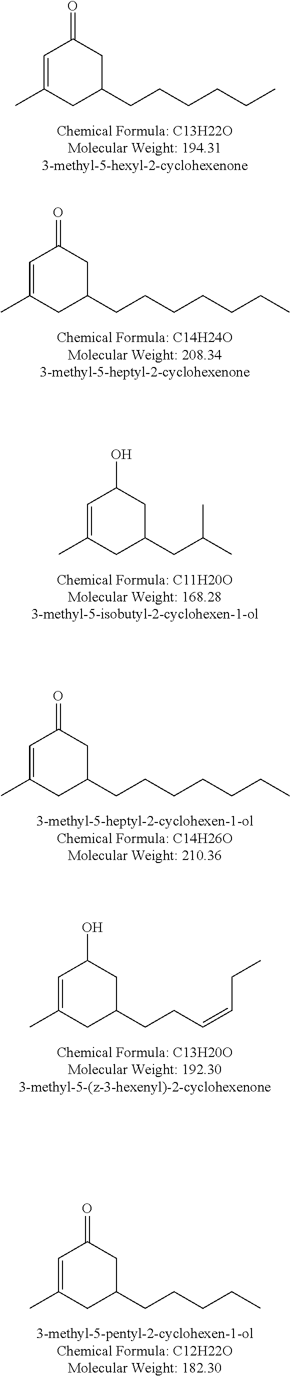

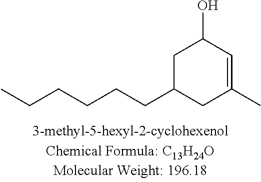

In another embodiment, the composition comprising at least one compound of structure (A) selected from methyl jasmonate, methyl dihydrojasmonate, methyl dihydrojasmolate (methyl 2-(3-hydroxy-2-pentylcyclopentyl)acetate), ethyl dihydrojasmonate, propyl dihydrojasmonate, apritone (cyclopentanone, 2-(3,7-dimethyl-2,6-octadienyl)-), and methyl apritone (cyclopentanone, 2-(3,7-dimethyl-2,6-nonadien-1-yl)-), is present in an amount from about 0.0001 to about 50% by weight or greater, based on the total weight of the composition.

In an embodiment, the at least one compound of structure (A) is methyl dihydrojasmonate (MDJ). MDJ is a mixture of two pairs of diasteromers, namely, the cis-enantiomers and the trans-enantiomers. MDJ having high cis-enantiomer may provide better performance in accordance with this disclosure. The cis-:trans-enantiomer ratio in MDJ is preferably from about 10:90 to about 90:10, or from about 15:85 to about 85:15, or from about 25:75 to about 75:25, or from about 30:70 to about 70:30, or from about 40:60 to about 60:40, or about 50:50.

In yet another embodiment, the composition comprising at least one compound of structure (A) selected from delta-dodecalactone, gamma-dodecalactone, gamma-undecalactone, gamma methyl dodecalactone, gamma-tridecalactone, gamma methyl tridecalactone, and gamma-tetradecalactone, is present in an amount from about 0.0001 to about 50% by weight or greater, based on the total weight of the composition.

In still another embodiment, the composition comprising at least one compound of structure (A) selected from 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, or 3-methyl-5-heptyl-2-cyclohexenone, is present in an amount from about 0.0001 to about 50% by weight or greater, based on the total weight of the composition.

The one or more compounds represented by structure (A) are present in the compositions of this disclosure in an amount from about 0.0001% by weight to about 50% by weight, or from about 0.0001% by weight to about 40% by weight, or from about 0.0001% by weight to about 30% by weight, or from about 0.0001% by weight to about 20% by weight, or from about 0.0001% by weight to about 10% by weight, or from about 0.0010% by weight to about 50% by weight, or from about 0.001% by weight to about 40% by weight, or from about 0.001% by weight to about 30% by weight, or from about 0.001% by weight to about 20% by weight, or from about 0.001% by weight to about 10% by weight, or from about 0.01% by weight to about 50% by weight, or from about 0.01% by weight to about 40% by weight, or from about 0.01% by weight to about 30% by weight, or from about 0.01% by weight to about 20% by weight, or from about 0.01% by weight to about 10% by weight, based on the total weight of the composition.

In an embodiment, the one or more compounds represented by structure (A) are present in the compositions of this disclosure in an amount from about 0.025% by weight to about 50% by weight, or from about 0.025% by weight to about 40% by weight, or from about 0.025% by weight to about 30% by weight, or from about 0.025% by weight to about 20% by weight, or from about 0.025% by weight to about 10% by weight, or from about 0.05% by weight to about 50% by weight, or from about 0.05% by weight to about 40% by weight, or from about 0.05% by weight to about 30% by weight, or from about 0.05% by weight to about 20% by weight, or from about 0.05% by weight to about 10% by weight, or from about 0.075% by weight to about 50% by weight, or from about 0.075% by weight to about 40% by weight, or from about 0.075% by weight to about 30% by weight, or from about 0.075% by weight to about 20% by weight, or from about 0.075% by weight to about 10% by weight, based on the total weight of the composition.

In an embodiment, the one or more compounds represented by structure (A) are present in the compositions of this disclosure in an amount of at least about 0.15 mM (0.003% by weight), or at least about 0.5 mM (0.011% by weight), or at least about 1.0 mM (0.023% by weight), or at least about 1.5 mM (0.034% by weight), or at least about 6.0 mM (0.136% by weight), or at least about 10.0 mM (0.226% by weight), or at least about 20.0 mM (0.452% by weight), in the composition.

The amount of the one or more compounds represented by structure (A) present in the compositions of this disclosure will depend upon the type of formulation used and the particular plant or seed which the formulation is employed.

In an embodiment, the one or more compounds represented by structure (A) are present in the compositions of this disclosure in an amount from about 0.00001 to about 50% by weight or greater, based on the total weight of the composition.

In another embodiment, the one or more compounds represented by structure (A) are present in the compositions of this disclosure in an amount from about 0.0001 to about 30% by weight or greater, based on the total weight of the composition.

In yet another embodiment, the one or more compounds represented by structure (A) are present in the compositions of this disclosure in an amount from about 0.001 to about 25% by weight or greater, based on the total weight of the composition.

In still another embodiment, the one or more compounds represented by structure (A) are present in the compositions of this disclosure in an amount from about 0.01 to about 20% by weight or greater, based on the total weight of the composition.

The amount of the one or more compounds represented by structure (A) present in the compositions of this disclosure will depend upon the type of composition used and the particular plant or seed to which the composition is employed, but will generally range from about 0.00001% to about 50% by weight, from about 0.00001% to about 30% by weight, or from about 0.00001% to about 25% by weight, or from about 0.000010% to about 20% by weight, or from about 0.00001% to about 15% by weight, or from about 0.00001% to about 10% by of the composition.

In an embodiment, the one or more compounds represented by structure (A) and the one or more biostimulants can be present in the composition of this disclosure in a weight ratio of the one or more compounds represented by structure (A) to the one or more biostimulants of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

In an embodiment, the one or more compounds represented by structure (A) and the one or more fertilizers can be present in the composition of this disclosure in a weight ratio of the one or more compounds represented by structure (A) to the one or more fertilizers of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

### Biostimulants

In an embodiment, the active ingredients in the compositions of this disclosure include one or more biostimulants. The one or more compounds represented by structure (A) of this disclosure may also be provided or co-administered with fertilizers.

Biostimulants include substances and/or microorganisms whose function, when applied to seeds, plants or the rhizosphere, is to stimulate natural processes to enhance/benefit nutrient uptake, nutrient efficiency, tolerance to abiotic stress, crop quality and/or yield

Illustrative biostimulants include, for example, acids, extracts, microbials, and assorted substances.

Acids include, for example, fulvic acids, amino acids, fatty acids/lipids, humic substances, humins, other organic acids, B vitamins, and the like.

Humic and fulvic acids are complex organic molecules of diverse structure and composition that form in the soil as byproducts of the decomposition and microbial metabolism of plant and animal residues. Humic substances are used to improve soil structure and function (e.g., chelate nutrients and improve cation exchange capacity, or CEC), enhance plant or seed nutrition, and contribute to improved crop yield and quality. They can be applied in various ways, including direct application to the soil, foliar application, incorporation into fertilizer and other products, and through irrigation water.

Amino acid products (along with other protein-derived biostimulants, based on peptides or protein hydrolysates) can be derived from the chemical or enzymatic hydrolysis of animal, plant, or microbial protein. The protein sources are often recycled waste products of agricultural crop residues or animal processing such as collagen, epithelial tissue, crustacean shells and other materials. Recycling these otherwise waste substances into useful agricultural products is a unique environmental benefit of protein-derived biostimulants. Other benefits of protein-derived biostimulants include, for example, improved soil fertility, better plant health and vigor, enhanced crop yields and quality, and improved stress tolerance.

Extracts include, for example, peptides, polyamines, seaweed/kelp, betaines, carboxyls, laminarin, alginates, other polysaccharides, polyphenols, botanicals, allelochemicals, other organic matter extracts, chitin/chitosan, phytohormones, and the like.

Seaweed extracts, also referred to as kelp or sea kelp extracts, provide benefits to soils and plants. Seaweed extracts improve soil properties (e.g., improve soil structure, water retention, and aeration), as well as helping to fix or chelate nutrients and improve CEC. Seaweed extracts have also aid in the functioning of beneficial soil microorganisms, and to improve the provisioning, uptake, and utilization of plant or seed nutrients, and also improve stress tolerance.

Illustrative plant extracts include, for example, allelochemicals. Allelochemicals are active plant compounds that can be extracted and concentrated.

Microbials include, for example, Rhizobium, complex communities/consortia, cytokinins, plant growth-promoting rhizobacteria (PGPR's), Mycorrhizae, Trichoderma, other beneficial fungi, and the like.

Illustrative microbials include, for example, fungi and bacteria. Microbial products can include “pure strain” fermentation solutions, based on individual isolates; consortia of admixed or co-fermented isolates; or much more complex “natural” communities derived from organic matter processing. Microbial products can enhance plant or seed growth through various direct and indirect mechanisms. Microbials can help with nutrient availability and uptake, improving soil condition, helping plants tolerate abiotic stress, and enhancing overall crop quality attributes.

Assorted substances include, for example, inorganic salts, proteins, phosphites, nitrogeneous compounds, enzymatic extracts, protein hydrolysates, beneficial elements like silicon, sodium, cobalt, and the like.

In some embodiments, the biostimulants of this disclosure may be combined with other active compounds that can be administered in the same fashion as the composition. A preferred composition includes combination with fertilizers.

The amount of the one or more biostimulants present in the compositions of this disclosure will depend upon the type of formulation used and the particular plant or seed which the formulation is employed.

In an embodiment, the one or more biostimulants are present in the compositions of this disclosure in an amount from about 0.00001 to about 50% by weight or greater, based on the total weight of the composition.

In another embodiment, the one or more biostimulants are present in the compositions of this disclosure in an amount from about 0.0001 to about 30% by weight or greater, based on the total weight of the composition.

In yet another embodiment, the one or more biostimulants are present in the compositions of this disclosure in an amount from about 0.001 to about 25% by weight or greater, based on the total weight of the composition.

In still another embodiment, the one or more biostimulants are present in the compositions of this disclosure in an amount from about 0.01 to about 20% by weight or greater, based on the total weight of the composition.

The amount of the one or more biostimulants present in the compositions of this disclosure will depend upon the type of composition used and the particular plant or seed to which the composition is employed, but will generally range from about 0.00001% to about 50% by weight, from about 0.00001% to about 30% by weight, or from about 0.00001% to about 25% by weight, or from about 0.00001% to about 20% by weight, or from about 0.00001% to about 15% by weight, or from about 0.000010% to about 10% by weight, or from about 0.000010% to about 5% by weight, based on the total weight of the composition.

In an embodiment, the one or more biostimulants and the one or more fertilizers can be present in the composition of this disclosure in a weight ratio of the one or more biostimulants to the one or more fertilizers of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

In accordance with this disclosure, benefits of biostimulants include, for example, nutrient uptake, nutrient efficiency, abiotic stress tolerance, and crop quality and/or yield.

Biostimulants enhance uptake and efficient use of nutrients, improve soil health by enhancing beneficial soil microorganisms, improve tolerance to abiotic stress: drought, extreme temperatures (cold, frost and heat) and salinity, enhance crop quality through plant health and vigor, and increase harvestable yields.

Biostimulants are a sustainable solution to agriculture challenges, such as increased agricultural demand necessitated by extreme weather and growing conditions related to climate change, and limited natural resources, water, soil, arable land.

In particular, biostimulant benefits include, for example, nutrient uptake, nutrient efficiency, abiotic stress tolerance, crop quality, and crop yield. The biostimulant benefits can provide sustainable agricultural outcomes including: water quality in which increased uptake of applied or existing nutrients reduces potential for runoff; water use in which greater yield from same or less water applied extends available supply for all uses; soil quality in which enhanced microbiome improves composition, organic content, and carbon sequestration; carbon emissions in which increased plant uptake of applied or existing nutrients reduces N₂O emissions; food loss in which improved quality increases harvest of marketable produce and grower profitability; and land use in which greater yield per acre reduces need to cultivate additional acres.

In accordance with this disclosure, plant biostimulants are substances and/or microorganisms whose function, when applied to seeds, plants or the rhizosphere, is to stimulate natural processes to enhance/benefit nutrient uptake, nutrient efficiency, tolerance to abiotic stress, crop quality and/or yield.

Plant biostimulant benefits in include, for example, improved nutrient use efficiency, improved abiotic stress tolerance, and improved crop quality traits. Improved nutrient use efficiency includes, for example, mobilization of nutrients (in soil), recruitment/acquisition of nutrients (e.g., stimulate root function, nutrient sensing, N-fixation), improved uptake, transport, storage and assimilation, and the like. Improved abiotic stress tolerance includes, for example, performance under physical or chemical stresses, common targets are heat, cold, water (flooding or drought), salinity, and the like. Improved crop quality traits include, for example, nutritional/nutraceutical value, color/cosmetics, shelf life, sizing, grade, pounds solids, and the like.

### Fertilizers

In an embodiment, the active ingredients in the compositions of this disclosure include one or more fertilizers. The one or more compounds represented by structure (A) of this disclosure may also be provided or co-administered with fertilizers. As used herein, fertilizers include plant or seed nutrients, and plant or seed growth components.

Fertilizers include any material of natural or synthetic origin that is applied to plant tissues or to soil to supply plant and seed nutrients. Fertilizers provide macro- and micro-nutrients. Many sources of fertilizer exist, both natural and industrially produced. Fertilization focuses on three main macro nutrients: nitrogen (N), phosphorus (P), and potassium (K) with optional addition of supplements like rock flour for micronutrients. Fertilizers are applied in a variety of ways such as through dry or pelletized or liquid application processes.

Illustrative fertilizers include, for example, organic fertilizers, cow dung manure fertilizers, bio-compost, leaf mould, vermicompost, chemical fertilizers, organic veggie mix, epsom salt, mustard cake powder, goat manure, and the like.

Organic fertilizers release nutrients slowly and steadily over a period. They increase the humus content of the soil, keeping the soil moist and overall improving health and quality of the soil. Cow Manure is an organic fertilizer providing slow release of nutrients. Bio-compost is compost manure obtained from the process of home or farm level composting. Leaf mould is a form of compost exclusively made by the fungal and bacterial breakdown of dry leaves. Vermicompost is manure obtained from the disintegration of organic waste by earthworms. Chemical fertilizers are available in granular or powdered or liquid form. Organic veggie mix is a 100% organic and all-natural fertilizer. Epsom salt is a fertilizer used as topsoil and mixed into the soil, improving the ability of the plant roots to absorb nutrients. Mustard cake powder is a 100% organic and all-natural fertilizer providing slow-release nutrition. Goat manure is like cow manure and used as topsoil/mulch.

Illustrative chemical fertilizers include, for example, nitrate fertilizers, phosphate fertilizers, potash fertilizers, mixed nitrogen:phosphorus:potassium (N:P:K) fertilizers, and the like.

Nitrate fertilizers (leaf makers) are high in nitrogen. Nitrate helps plants to grow faster by encouraging the formation of more leaves. Illustrative nitrtes include, for example, ammonium sulphate, ammonium chloride, calcium-ammonium nitrate, urea, and the like.

Phosphate fertilizers (root makers) are high in phosphorus. Phosphates encourage root formation and rapid root growth, thus helping the overall growth of plants. Illustrative phosphates include, for example, single super phosphate, basic slag, rock phosphate, and the like.

Potash fertilizers (fruit makers) are high in potassium. Potash fertilizers encourage flower and fruit formation in plants. Common potash includes muriate of potash (60%) and sulphate of potash (50%).

Mixed fertilizers are combinations of nitrogen:phosphorus:potassium (NPK). Proper and balanced NPK fertilizer helps overall growth of leaves, roots, fruits, and flowers. Illustrative NPK combinations include, for example, nitrophosphate (20:20:0), mono ammonium phosphate (11:18:0), diammonium phosphate (21:54:0), nitrophosphate with potash-suphala (15:15:15), sampurna (19:19:19).

Illustrative plant or seed nutrients essential for plant or seed growth, include, for example, primary plant or seed nutrients including nitrogen, phosphorus, and potassium; secondary plant or seed nutrients including calcium, magnesium, and sulfur; and micronutrients including boron, copper, iron, manganese, molybdenum, zinc, and chlorine.

For the primary plant and seed nutrients, nitrogen is the growth element that promotes green, leafy growth. As a primary component of proteins, nitrogen is part of every living cell. Inside the plant, nitrogen is converted into amino acids, the building blocks for proteins. Because all enzymes are proteins, nitrogen is necessary for enzymatic reactions in plants. Phosphorus is essential in energy transformations in the plant. Potassium is essential for photosynthesis, as regulation of cell turgidity, respiration, and water movement in the plant. It also controls the opening and closing of the plant's stomata.

For the secondary plant and seed nutrients, calcium stimulates root and leaf development. It forms compounds that are part of cell walls and strengthens plant structure. Magnesium is part of the chlorophyll molecule, so it is actively involved in photosynthesis. Magnesium aids in phosphate metabolism and plant respiration and sets in motion several enzyme systems. Sulfur, like nitrogen, is essential in protein formation because it is an essential component of three amino acids: methionine, cysteine, and cystine.

For the micronutrients, boron (B) is critical for cell wall structure and function in the plant. Copper (Cu) is present in several enzymes and certain plant proteins. Iron (Fe) is necessary for the maintenance of chlorophyll in plants. Manganese (Mn) activates many enzymes. Molybdenum (Mo) is required for the normal assimilation of nitrogen in plants. Zinc (Zn) is essential in selected enzymatic reactions. Chlorine (Cl) is known to be an essential nutrient.

In some embodiments, the fertilizers of this disclosure may be combined with other active compounds that can be administered in the same fashion as the composition. A preferred composition includes combination with biostimulants.

The amount of the one or more fertilizers present in the compositions of this disclosure will depend upon the type of formulation used and the particular plant or seed which the formulation is employed.

In an embodiment, the one or more fertilizers are present in the compositions of this disclosure in an amount from about 0.00001 to about 50% by weight or greater, based on the total weight of the composition.

In another embodiment, the one or more fertilizers are present in the compositions of this disclosure in an amount from about 0.0001 to about 30% by weight or greater, based on the total weight of the composition.

In yet another embodiment, the one or more fertilizers are present in the compositions of this disclosure in an amount from about 0.001 to about 25% by weight or greater, based on the total weight of the composition.

In still another embodiment, the one or more fertilizers are present in the compositions of this disclosure in an amount from about 0.01 to about 20% by weight or greater, based on the total weight of the composition.

The amount of the one or more fertilizers present in the compositions of this disclosure will depend upon the type of composition used and the particular plant or seed to which the composition is employed, but will generally range from about 0.00001% to about 50% by weight, from about 0.00001% to about 30% by weight, or from about 0.00001% to about 25% by weight, or from about 0.000010% to about 20% by weight, or from about 0.00001% to about 15% by weight, or from about 0.00001% to about 10% by weight, or from about 0.000010% to about 5% by weight, based on the total weight of the composition.

In an embodiment, the one or more fertilizers and the one or more biostimulants can be present in the composition of this disclosure in a weight ratio of the one or more fertilizers to the one or more biostimulants of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

In accordance with this disclosure, biostimulants and fertilizers have been described as separate components having different functions. However, in some situations, fertilizers may be considered as biostimulants. This disclosure, and the interpretation of the claims herein, are not intended to be limited in any manner with respect to any classification or distinction between biostimulants and fertilizers, whether governmental, regulatory, or otherwise.

The compositions described herein can be prepared by any convenient means, e.g., by mixing the one or more active compounds of structure (A) and the one or more biostimulants, or one or more fertilizers, or a combination of one or more biostimulants and one or more fertilizers, with one or more other carriers or vehicles, adjuvants or additives, such as, including but not limited to, those described herein.

### Adjuvants or Additives

The compositions of this disclosure may be used with an agronomically acceptable carrier. The term “agronomically acceptable carrier” includes any carrier suitable for administration to a plant, seed or soil, for example, customary excipients in formulation techniques, such as solutions (e.g., directly sprayable or dilutable solutions), emulsions, (e.g., emulsion concentrates and diluted emulsions), wettable powders, suspensions, soluble powders, powders, dusts, pastes, soluble powders, granules, suspension-emulsion concentrates, encapsulation into polymeric materials, coatable pastes, natural and synthetic materials impregnated with active compound and micro-encapsulations in polymeric substances. These formulations are produced in a known manner, for example, by mixing the compounds with agronomically acceptable carrier, such as liquid solvents or solid carriers, optionally with the use of surfactants, including emulsifiers, dispersants, and/or foam-formers.

If the agronomically acceptable carrier is water, organic solvents can also be employed, for example, as auxiliary solvents. Suitable liquid solvents include, for example, aromatics (e.g., xylene, toluene and alkylnaphthalenes); chlorinated aromatics or chlorinated aliphatic hydrocarbons (e.g., chlorobenzenes, chloroethylenes and methylene chloride); aliphatic hydrocarbons (e.g., cyclohexane); paraffins (e.g., petroleum fractions, mineral and vegetable oils); alcohols (e.g., butanol or glycol and also their ethers and esters); ketones (e.g., acetone, methyl ethyl ketone, methyl isobutyl ketone and cyclohexanone) and strongly polar solvents (e.g., dimethylformamide and dimethyl sulphoxide). Nontoxic carriers are used in the methods of the present disclosure.

Other solid agronomically acceptable carriers include, for example, ammonium salts and ground natural minerals (e.g., kaolins, clays, talc, chalk, quartz, attapulgite, montmorillonite and diatomaceous earth); ground synthetic minerals (e.g., highly disperse silica, alumina and silicates); crushed and fractionated natural rocks (e.g., calcite, marble, pumice, sepiolite and dolomite); synthetic granules of inorganic and organic meals; granules of organic material (e.g., sawdust, coconut shells, maize cobs and tobacco stalks).

The one or more compounds represented by structure (A) can be applied alone or in a formulation comprising other elements, compounds, or substances. Some examples of other compounds useful in the compositions of this disclosure include, for example, wetting agents, adjuvants, emulsifiers, dispersants, spreaders, stickers, pastes, anchorage agents, fixatives, extenders, coating agents, buffering agents, absorptive additives, and disintegrants. The formulation may also include acids, bases, or other compounds that adjust or maintain the final pH of the composition in order to increase solubility of certain compounds in the composition or for other reasons. Those of skill in the art will recognize that a single ingredient may perform multiple functions, and may thus be classified or grouped in different ways.

The compositions of this disclosure may also include fixative and extender compounds, in order to reduce volatility and evaporation of the active ingredient or ingredients, so as to increase exposure of the plant or seed to the active ingredient. Exemplary fixatives include canola oil, castor oil, benzoyl benzoate, benzyl salicylate and synthetic musks, and sandalwood. Gums, waxes, and other carbohydrates, such as carnauba wax, carob gum, dextrins, dextrose, gellan gum, guar gum, paraffin wax, sorbitol, xanthan gum, polyvinylpyrrolidone, and glycerin, may also be used as fixatives.

Absorptive additives may also be included for extending the release and exposure time. Exemplary absorptive additives include, but are not limited to, silica gel; precipitated crystalline-free silica gel; amorphous, fumed, crystalline-free silica; amorphous, precipitated gel silica; silica hydrate; vitreous silica; silicic acid; and silicon dioxide.

Some emulsifiers and foam-formers that can be used include, for example, nonionic and anionic emulsifiers (e.g., polyoxyethylene fatty acid esters, polyoxyethylene fatty alcohol ethers, for example, alkylaryl polyglycol ethers, alkylsulphonates, alkyl sulphates and arylsulphonates) protein hydrolysates. Suitable dispersants include, for example, lignin-sulphite waste liquors and methylcellulose.

Particular examples of formulation ingredients include ionic, non-ionic, and zwitterionic surfactants, such as TRITON®X-100, TRITON®X-114, NP-40, SILWET, and sodium dodecyl sulfate; alcohols; synthetic or natural oils, such as castor oil, canola (rapeseed) oil, and soybean oil; soaps; and adjuvants derived from natural sources, such as lecithin, saponin, cocodiethanolamide, and extracts from yucca, coconut, and pine. Additionally, for example, citric acid may be used to acidify a formulation, and compounds such as dipotassium phosphate, calcium carbonate, and potassium silicate may be used to raise the pH.

In some embodiments, it may be beneficial to use ingredients that are high in compounds that play a role in the octadecanoic pathway. For example, canola oil is high in linoleic and linolenic acids, compounds that play a role in the octadecanoic pathway. Soaps of linoleic, linolenic, and cis-7,10,13-hexadecatrienoic acids may also be desirable formulation ingredients in some embodiments.

The amount of the one or more additives present in the compositions of this disclosure will depend upon the type of composition used and the particular plant or seed to which the composition is employed, but will generally range from about 0.00001% to about 50% by weight, from about 0.0001% to about 30% by weight, or from about 0.001% to about 25% by weight, or from about 0.01% to about 20% by weight, or from about 0.01% to about 15% by weight, or from about 0.01% to about 10% by weight, or from about 0.01% to about 5% by weight, based on the total weight of the composition.

The one or more compounds represented by structure (A) may be present in the compositions of this disclosure in weight/weight ratios of the one or more compounds represented by structure (A) to other ingredients (e.g., adjuvants or additives). The weight/weight ratios can be, for example, about 0.00001/10, or about 0.00001/7.5, or about 0.00001/5, or about 0.00001/2.5, or about 0.00001/1, or about 0.00001/0.75, or about 0.00001/0.5, or about 0.00001/0.25, or about 0.00001/0.1.

### Environmental Streses

The method of this disclosure protects plants and seeds from stress injury resulting from environmental stresses. Environmental stresses include biotic stresses and abiotic stresses.

Biotic stresses are induced by a living organism such as a virus, bacteria, fungi, viroid, phytoplasma, nematode, insect, pathogen, arachnid, and weed.

Abiotic stresses are induced, for example, by desiccation, salt, drought, osmotic, temperature, wind, water, light, heavy metals, cold, heat, ozone, ultraviolet (UV) radiation, and nutrient deficiency.

### Plants and Seeds

Plants and seeds to which the compositions of this disclosure can be applied to protect against stress injuries resulting from environmental stresses include, but are not limited to, angiosperms, gymnosperms, monocots, dicots, roses, tomatoes, crop plants, ornamental plants, turf plants, shrubs, trees, exotic plants, house plants, and native plants in cultivated or natural environments.

In an embodiment, plants and seeds to which the compositions of this disclosure can be applied to protect against stress injuries resulting from environmental stresses include, for example, those plants and seeds from food crops, forage crops, fiber crops, oil crops, ornamental crops, industrial crops, and the like.

Illustrative food crops include, for example, cereals, fruits, vegetables, spices, and the like.

Illustrative cereals include, for example, wheat, rice, barley, millet, oats, rye, maize, sorghum; the fruits are selected from the group consisting of apples, pears, citrus, stone fruits, tropical fruits, exotic fruits, and berries; the vegetables are selected from the group consisting of root vegetables including beets, carrots, sweet potatoes, turnips; tubers: potatoes, yams; stem vegetables including asparagus, kohlrabi, celery; leafy green vegetables including lettuce, spinach, and silverbeet; allium or bulb vegetables including garlic, leeks, onions, and shallots; head or flower vegetables including artichokes, cabbage, and cauliflower; cucumber family vegetables including pumpkin, cucumber, and zucchini; and spices including pepper, ginger, spice seeds, herbs, and the like.

Illustrative forage crops include, for example, sorghum, alfalfa, barley, oats, millet, soybeans, wheat, maize, hay, silage, and the like.

Illustrative fiber crops include, for example, cotton, hemp, jute, kenaf, flax, and the like.

Illustrative oil crops include, for example, soybeans, sunflower seeds, rapeseed, canola, carmelina, palm, peanuts, and the like.

Illustrative ornamental crops include, for example, ivy, oleander, holly, tulips, roses, azaleas, and the like.

Illustrative industrial crops include, for example, cotton, jute, sugarcane, sugarbeet, coffee, tea, tobacco, coconut, soybeans, and the like.

Illustrative seeds include, for example, cereals, nuts, legumes, spices, and the like.

Contacting a plant or plant part with a composition of the disclosure can result in plant beneficial protection in the root, stem, leaf, seed, flower, and/or combinations thereof. In an embodiment, the plant may be a dicot, a monocot, an annual, a perennial, a crop plant, alfalfa, rice, wheat, barley, rye, cotton, sunflower, peanut, corn, oat, millet, flax, potato, sweet potato, bean, green bean, wax bean, lima bean, pea, chicory, lettuce, endive, cabbage, brussel sprout, beet, sugar beet, parsnip, turnip, cauliflower, broccoli, turnip, radish, spinach, onion, garlic, eggplant, pepper, celery, carrot, squash, pumpkin, zucchini, cucumber, melon, yam, carrots, cassava, citrus, strawberry, grape, raspberry, pineapple, soybean, tobacco, tomato, sorghum, sugarcane, ornamental plant, Arabidopsis thaliana, Saintpaulia, petunia, Pelargonium, Poinsettia, Chrysanthemum, carnation, Zinnia, poplar, apple, pear, peach, cherry, almond, plum, hazelnuts, banana, apricot, grape, kiwi, mango, melon, papaya, walnut, pistachio, raspberry, blackberry, loganberry, blueberry, cranberry, orange, lemon, grapefruit, tangerine, avocado, or cocoa, and the like.

### Application and Treatment

In an embodiment, this disclosure relates to a method of protecting plants or seeds from stress injury resulting from environmental stresses by treating the plants or seeds with a protective amount of a composition of this disclosure. The one or more compounds represented by structure (A) of this disclosure may be in a variety of different forms, including emulsions, suspensions, powders, hydrates, solutions, granules, pastes, aerosols, and volatile formulations, and other additives and compounds may be included in the formulation. In one embodiment, the compositions of this disclosure may be in the form of an aqueous solution, accompanied by a surfactant and an oil. The one or more compounds represented by structure (A) of this disclosure are provided or co-administered with biostimulants, fertilizers, and/or combinations thereof. After treatment, in some embodiments, the plant or seed, or a portion thereof, may be harvested.

In another embodiment, if the one or more compounds represented by structure (A) of this disclosure are delivered in the form of a solution, they may be in solution with any compatible solvent, including aqueous (water) solutions, alcohol (e.g., ethanol) solutions, or in combinations of solvents (e.g., water/ethanol). In general, a “compatible solvent,” as the term is used herein, refers to any solvent in which the one or more compounds represented by structure (A) of this disclosure are at least slightly soluble and which is not phytotoxic in the amounts or concentrations used to apply the one or more compounds represented by structure (A).

In an embodiment, the composition of this disclosure is used to protect plants and seeds from stress injury resulting from abiotic stress including cold shock, drought/water deficit stress in field applications by applying the composition in an aqueous medium to drip irrigation water/other means of irrigation, or with pesticide or fertilizer application at planting, or post planting during growth season until harvest. Treatment of plants and soil with the composition of this disclosure can be carried out directly or by allowing the compounds to act on the surroundings, environment, or storage space by the customary treatment methods, for example by immersion, spraying, evaporation, fogging, scattering, painting on and, in the case of propagation material, in particular in the case of seeds, also by applying one or more coats. The composition in an aqueous medium can be applied at regular intervals (e.g., every 20-30-day intervals) to the plant roots in the greenhouse or in the field.

The compositions of this disclosure can be applied by coating plant seeds, or germinating seedling roots, before they are planted, or by drenching the roots of existing plants, in situ or in the course of transfer, or by introducing the composition onto the bases of target plants. The application of the composition to target plants protects the plants from stress injury resulting from environmental stresses, for example, pests and pathogens, increases resistance to cold stress, increases drought tolerance, and/or combinations thereof. Application of the compositions of this disclosure to target plants and seeds can promote plant and seed growth, health and protects plants from stress injury resulting from abiotic and biotic stresses. Additionally, application of the compositions of this disclosure to target plants can induce plant tolerance to abiotic and biotic stresses including tolerance to low temperature/cold stress, freezing stress, high temperature/heat stress, salt/salinity stress, low (shading stress) or excessive light (ultraviolet (UV) radiation and other cosmic radiation), microgravity stress, which causes flooding response in plants, oxidative stress, heavy metal stress, lack of oxygen conditions, flooding, drought/water deficit, and/or combinations thereof.

The compositions of this disclosure can be administered to the plant, seed, soil, and/or plant environments surrounding the plants by any techniques known in the art, including, for example, spraying, atomizing, dusting, scattering, coating, or pouring. One of skill in the art would be able to determine the appropriate technique for administration without undue experimentation according to the specific abiotic or biotic stress to be combated, the specific chemical composition and formulation of the compound being employed, the method of applying the compound/formulation, and the locus of treatment.

In an embodiment, the compositions of this disclosure can be administered by foliar application. In another embodiment, the compositions can also reach the plants through the root system via the soil by drenching the locus of the plant with a liquid preparation or by incorporating the substances into the soil in solid form, e.g., in the form of granules (soil application). In rice cultivations, these granules can be dispensed over the flooded paddy field. The compositions of the present disclosure may also be applied to tubers or seed grain, for example, by soaking, spraying, or drenching the seed grain or tubers in a liquid composition or by coating the tubers or seed grain with a solid composition.

The active compounds of structure (A) may be formulated into any suitable formulations such as for example, including but not limited to, solutions, aerosols or the like. Traditional inert carriers such as, including but not limited to, alcohols, esters and petroleum distillates, could be used to produce formulations of the active compounds. Another series of carriers are the biodegradable oils, including but not limited to, the Olestra® family of oils, isopropyl myristate and squalane.

When the composition is used as an aerosol, it is preferable to add a propellant. Suitable propellants include propane, butane, isobutane, dimethyl ether, carbon dioxide, nitrous oxide, nitrogen, and combinations thereof.

Forms of the one or more compounds represented by structure (A) may be adapted for application to the plant's foliage, roots, stems, flowers, or any other portion of the plant that is capable of absorbing it. Particularly advantageous forms include foliar sprays, root solutions, and pellet-based root preparations.

As a root solution or preparation, the one or more compounds represented by structure (A) may be formulated and applied to plants grown in soil, non-soil, artificial growing media, and/or hydroponic systems.

In an embodiment, the one or more compounds represented by structure (A) are applied in a “protective amount” sufficient to elicit a protective response in a plant or seed. For purposes of this disclosure, a protective amount of the one or more compounds represented by structure (A) is any amount that elicits a noticeable protective response in a plant or seed, as compared with untreated plants or seeds.

In an embodiment, the one or more compounds represented by structure (A) are applied in an “effective amount” sufficient to induce tolerance in a plant or seed to an environmental stress. For purposes of this disclosure, an effective amount of the one or more compounds represented by structure (A) is any amount that induces noticeable tolerance in a plant or seed to an environmental stress, as compared with untreated plants or seeds.

In another embodiment, the one or more compounds represented by structure (A) are applied in an “effective amount” sufficient to improve a germination characteristic of a seed. For purposes of this disclosure, an effective amount of the one or more compounds represented by structure (A) is any amount that improves a germination characteristic of a seed, as compared with untreated seeds.

Protective amounts and effective amounts of the one or more compounds represented by structure (A) in the compositions of this disclosure will vary from species to species and cultivar to cultivar, and will depend on the manner of application, the environmental conditions around the plant or seeds, the form in which the composition is administered, and the nature and type of additive compounds, if any, present in the compositions.

For example, if a composition is applied over a substantial portion of a plant's foliage, or is applied using a formulation that includes wetting agents, fixatives, and/or other additives intended to increase the level of exposure of the plant to the composition, the formulation itself may contain a smaller amount or lower concentration of the one or more compounds represented by structure (A) than if the composition is applied over only a small portion of a plant's foliage, or without additives intended to increase the plant's exposure to the one or more compounds represented by structure (A). Similarly, if the one or more compounds represented by structure (A) are administered in a form that tends to dwell on the plant's foliage, or in proximity to another part of the plant, then it may be administered in a lower concentration or amount.

As one example, an effective amount of the one or more compounds represented by structure (A) for inducing noticeable tolerance in a plant or seed to an environmental stress may comprise an aqueous solution with a concentration of the one or more compounds represented by structure (A) in the range from about 0.001 wt % to about 5 wt %, inclusive, based on the total weight of the composition. However, for some purposes, and in some species, concentrations up to about 10 wt % may be used. As those of skill in the art will realize, in general, the one or more compounds represented by structure (A) may be used in even higher concentrations for some applications, provided that the total dose of the one or more compounds represented by structure (A) that is absorbed by the plant is not phytotoxic. Similarly, lower concentrations may be adequate in some situations, for example, in an enclosed environment or greenhouse.

In addition to liquid and aqueous preparations, the one or more compounds represented by structure (A) may be formulated for use in a slow-release application and provided in a granular-based or pellet-based form, including biostimulant, fertilizer and/or combinations thereof. The one or more compounds represented by structure (A) may be present in those formulations in weight/weight ratios of the one or more compounds represented by structure (A) to other ingredients in the range of 0.001% to 10%, and in some cases an effective ratio could be greater than 10% or less than 0.001%. Other inert or nutritive ingredients included in the pellets or granules can include binding agents and polymers, such as polysaccharides and polyvinylpyrrolidone, at 5-95%, a surfactant at 0.001-10%, and other absorptive ingredients, such as acrylamide and acrylamide polymers.

Formulations including the one or more compounds represented by structure (A) may be applied once or repeatedly, depending on the circumstances and the type of formulation, to treat a plant or seed. For example, formulations according to embodiments of this disclosure may be applied to the roots, foliage or some other part of a plant once or, alternatively, two or more times at defined intervals of time, such as every 2-14 days, every 30 days, or 1-2 times per month. The intervals at which the one or more compounds represented by structure (A) are applied may vary. A plant or seed may be treated with the one or more compounds represented by structure (A) whether or not the environmental stress is present at the time of treatment. Additionally, plants and seeds may be treated with the one or more compounds represented by structure (A) for protection from stress injury resulting from environmental stress whether they are healthy or not.

Among other factors, the environmental conditions around the plant or plants may influence the manner in which the one or more compounds represented by structure (A) are applied or their frequency. For example, if the plants are field-grown or otherwise exposed to the elements, rain showers, excessive wind gusts, or other environmental factors shortly after an application, it may be desirable to reapply the one or more compounds represented by structure (A). Under some circumstances, a more dilute formulation or solution may be used if repeated applications are to be performed.

Optionally, in at least some embodiments, a plant treated with the one or more compounds represented by structure (A), or a portion thereof, may be harvested some time after the plant is treated with the one or more compounds represented by structure (A). Harvesting may occur shortly after (e.g., several days after) treatment, or it may occur after sustained, relatively long-term treatment with the one or more compounds represented by structure (A) (e.g., several weeks or several months of treatment at regular intervals).

For foliar application, the compositions of this disclosure can be applied at a rate of 50-1000 ml/acre, or 75-900 ml/acre, or 100-800 ml/acre, or 125-700 ml/acre, or 150-600 ml/acre, or 175-500 ml/acre, or 200-400 ml/acre, of crop.

The composition may be applied to plants or seeds. The composition is applied to the plants or seeds such that the amount of the one or more compounds represented by structure (A) applied is about 0.125 g/m² to about 150 g/m², or about 0.125 g/m² to about 140 g/m², or about 0.125 g/m² to about 130 g/m², or about 0.125 g/m² to about 120 g/m², or about 0.125 g/m² to about 110 g/m², or about 0.125 g/m² to about 100 g/m², or about 0.125 g/m² to about 90 g/m², or about 0.125 g/m² to about 80 g/m², or about 0.125 g/m² to about 70 g/m², or about 0.125 g/m² to about 60 g/m², or about 0.125 g/m² to about 50 g/m², or about 0.125 g/m² to about 40 g/m², or about 0.125 g/m² to about 30 g/m², or about 0.125 g/m² to about 25 g/m², or about 0.125 g/m² to about 20 g/m², or about 0.125 g/m² to about 15 g/m², or about 0.125 g/m² to about 10 g/m², or about 0.125 g/m² to about 5 g/m².

The composition may be applied to plants and seeds to protect the plants and seeds from stress injury resulting from environmental stress, and/or to induce tolerance in plants and seeds to biotic and abiotic stresses.

### Synergy

In an embodiment, a synergistic effect can be exhibited with the formulations of this disclosure.

Depending on the plant species or plant cultivars, their location and growth conditions (e.g., soils, climate, vegetation period, diet), the treatment according to the disclosure may also result in a synergistic effect. Thus, for example, reduced application rates and/or a widening of the activity spectrum and/or an increase in the activity of the substances and compositions to be used, better plant and seed growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products that exceed the effects which were actually to be expected may occur.

Additionally, for example, reduced leaf yellowing, reduced leaf death, reduced plant wilting, reduced destruction of chloroplasts, reduced degradation of chlorophyll in leaves, reduced leaf browning, reduced leaf wilting or curling, reduced plant death, reduced leaf lesions, reduced seed death, reduction of retarded seed germination, increased seed germination, reduced plant death, increased shoot meristem growth, reduction of retarded growth (root and shoot) seedlings, increased growth (root and shoot) seedlings, increased rate of seed germination, increased lower root and shoot fresh weight, and/or increased seedling vigor, that exceed the effects which were actually to be expected may occur.

### PREFERRED EMBODIMENTS

Preferred embodiments of this disclosure are set forth in the clauses below.

1. A method of protecting a plant or seed from stress injury resulting from an environmental stress; and supporting one or more natural plant or seed processes, or supporting plant or seed nutrition, or a combination thereof; said method comprising applying to at least a portion of said plant or seed a composition comprising:
i) one or more compounds represented by structure (A):

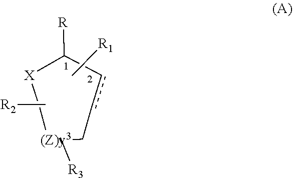

wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is 0 or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds represented by structure (A); and
ii) one or more biostimulants, or one or more fertilizers, or a combination thereof;
wherein the one or more compounds represented by structure (A) are present in the composition in a protective amount sufficient to elicit a protective response in the plant or seed to the environmental stress; and, when present, the one or more biostimulants are present in the composition in an amount sufficient to support one or more natural plant or seed processes; and, when present, the one or more fertilizers are present in the composition in an amount sufficient to support plant or seed nutrition.

2. The method according to clause 1 wherein the one or more compounds represented by structure (A) are present in the composition in an amount from about 0.000010% by weight to about 50% by weight, or in an amount from about 0.00010% by weight to about 40% by weight, or in an amount from about 0.0010% by weight to about 30% by weight, based on the total weight of the composition.

3. The method of clause 1 wherein the one or more biostimulants are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

4. The method of clause 1 wherein the one or more fertilizers are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

5. The method of clause 1 wherein the one or more compounds represented by structure (A) and the one or more biostimulants are present in the composition in a weight ratio of the one or more compounds represented by structure (A) to the one or more biostimulants of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

6. The method of clause 1 wherein the one or more compounds represented by structure (A) and the one or more fertilizers are present in the composition in a weight ratio of the one or more compounds represented by structure (A) to the one or more fertilizers of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

7. The method according to clause 1 wherein the environmental stress is a biotic stress or an abiotic stress.

8. The method according to clause 7 wherein the biotic stress is induced by a living organism selected from the group consisting of a virus, bacteria, fungi, viroid, phytoplasma, nematode, insect, pathogen, arachnid, and weed.

9. The method according to clause 7 wherein the abiotic stress is selected from the group consisting of desiccation, salt, drought, osmotic, temperature, wind, water, light, heavy metals, cold, heat, ozone, ultraviolet (UV)
radiation, and nutrient deficiency.

10. The method according to clause 1 wherein the stress injury comprises plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, and/or reduced seedling vigor.

11. The method of clause 1 wherein the natural plant or seed processes are selected from the group consisting of photosynthesis, respiration, growth, transpiration, and nutrient uptake.

12. The method of clause 1 wherein the natural plant or seed processes are supported to enhance at least one of nutrient uptake, nutrient efficiency, abiotic stress tolerance, crop quality, and crop yield.

13. The method of clause 1 wherein plant or seed nutrition is supported to enhance plant or seed growth.

14. The method of clause 1 wherein plant or seed nutrition is supported by chemical fertilizers selected from the group consisting of nitrate fertilizers, phosphate fertilizers, potash fertilizers, and mixed nitrogen:phosphorus:potassium (N:P:K) fertilizers.

15. The method of clause 1 wherein plant or seed nutrition is supported by plant or seed nutrients essential for plant or seed growth, including primary plant or seed nutrients selected from the group consisting of nitrogen, phosphorus, and potassium; secondary plant or seed nutrients selected from the group consisting of calcium, magnesium, and sulfur; and micronutrients selected from the group consisting of boron, copper, iron, manganese, molybdenum, zinc, and chlorine.

16. The method according to clause 1 wherein the plant or seed is selected from the group consisting of food crops, forage crops, fiber crops, oil crops, ornamental crops, and industrial crops.

17. The method according to clause 16 wherein the food crops are selected from the group consisting of cereals, fruits, vegetables, and spices.

18. The method according to clause 17 wherein the cereals are selected from the group consisting of wheat, rice, barley, millet, oats, rye, maize, sorghum; the fruits are selected from the group consisting of apples, pears, citrus, stone fruits, tropical fruits, exotic fruits, and berries; the vegetables are selected from the group consisting of root vegetables including beets, carrots, sweet potatoes, turnips; tubers: potatoes, yams; stem vegetables including asparagus, kohlrabi, celery; leafy green vegetables including lettuce, spinach, and silverbeet; allium or bulb vegetables including garlic, leeks, onions, and shallots; head or flower vegetables including artichokes, cabbage, and cauliflower; cucumber family vegetables including pumpkin, cucumber, and zucchini; and spices including pepper, ginger, spice seeds, and herbs.

19. The method according to clause 16 wherein the forage crops are selected from the group consisting of sorghum, alfalfa, barley, oats, millet, soybeans, wheat, maize, hay, and silage.

20. The method according to clause 16 wherein the fiber crops are selected from the group consisting of cotton, hemp, jute, kenaf, and flax.

21. The method according to clause 16 wherein the oil crops are selected from the group consisting of soybeans, sunflower seeds, rapeseed, canola, carmelina, palm, and peanuts.

22. The method according to clause 16 wherein the ornamental crops are selected from the group consisting of ivy, oleander, holly, tulips, roses, and azaleas.

23. The method according to clause 16 wherein the industrial crops are selected from the group consisting of cotton, jute, sugarcane, sugarbeet, coffee, tea, tobacco, coconut, and soybeans.

24. The method according to clause 16 wherein the seeds are selected from the group consisting of cereals, nuts, legumes, and spices.

25. The method according to clause 1 wherein the plant is a root, a stem, a leaf, a seed, a flower, or part thereof.

26. The method according to clause 1 wherein the plant is a dicot, monocot, annual, perennial, crop plant, alfalfa, rice, wheat, barley, rye, cotton, sunflower, peanut, corn, oat, millet, flax, potato, sweet potato, bean, green bean, wax bean, lima bean, pea, chicory, lettuce, endive, cabbage, brussel sprout, beet, sugar beet, parsnip, turnip, cauliflower, broccoli, turnip, radish, spinach, onion, garlic, eggplant, pepper, celery, carrot, squash, pumpkin, zucchini, cucumber, melon, yam, carrots, cassava, citrus, strawberry, grape, raspberry, pineapple, soybean, tobacco, tomato, sorghum, sugarcane, ornamental plant, Arabidopsis thaliana, Saintpaulia, Petunia, pelargonium, Poinsettia, Chrysanthemum, carnation, Zinnia, poplar, apple, pear, peach, cherry, almond, plum, hazelnuts, banana, apricot, grape, kiwi, mango, melon, papaya, walnut, pistachio, raspberry, blackberry, loganberry, blueberry, cranberry, orange, lemon, grapefruit, tangerine, avocado, or cocoa.

27. The method according to clause 1 wherein the one or more compounds represented by structure (A) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

28. The method according to clause 1 wherein the one or more compounds represented by structure (A) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

29. The method according to clause 1 wherein the one or more compounds represented by structure (A) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

30. The method according to clause 1 wherein the one or more compounds represented by structure (A) are selected from the group consisting of:

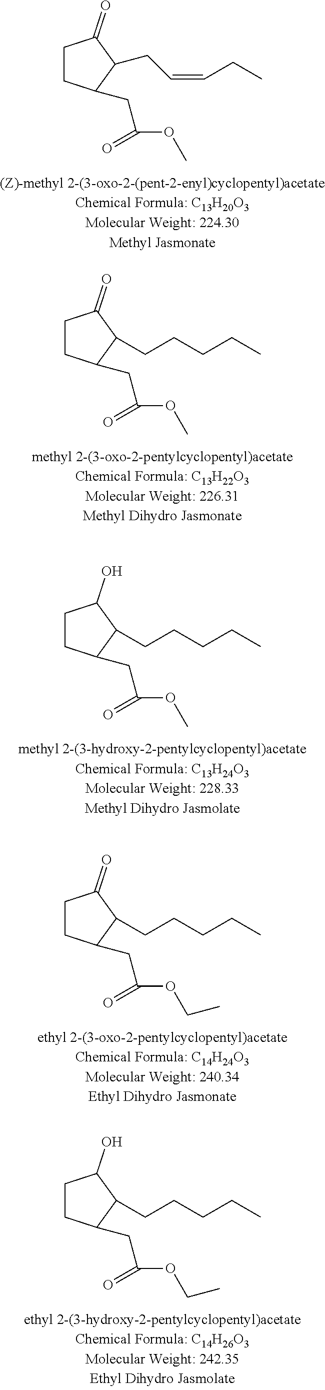 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC]

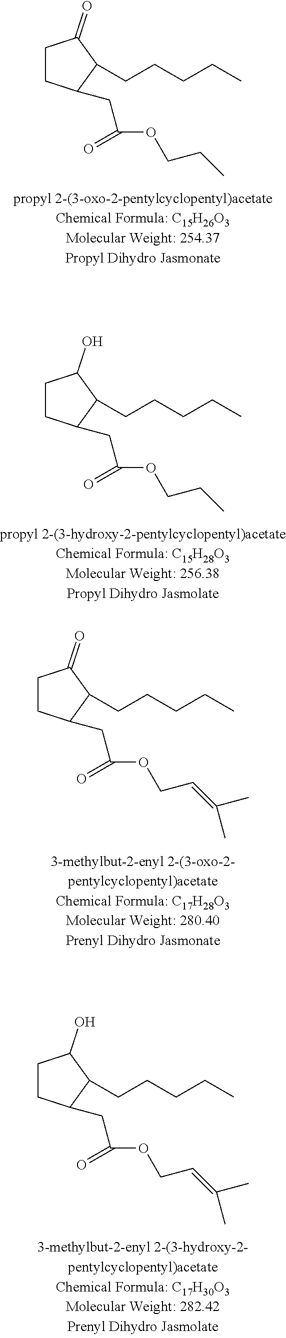 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

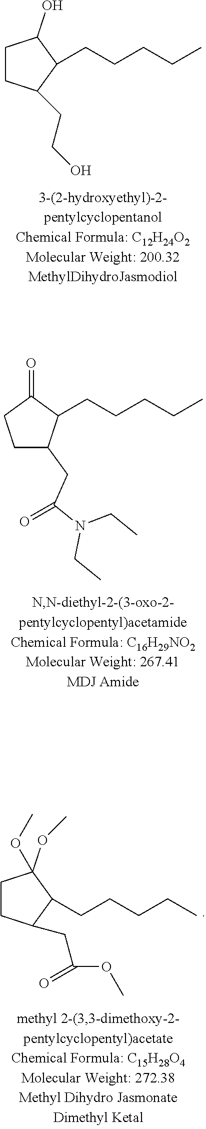 [SMILES: CCCCCC1C(O)CCC1CCO ; CCCCCC1C(=O)CCC1CC(=O)N(CC)CC ; CCCCCC1C(CC(=O)OC)CCC1(OC)OC]

31. The method according to clause 1 wherein the one or more compounds represented by structure (A) are selected from the group consisting of:

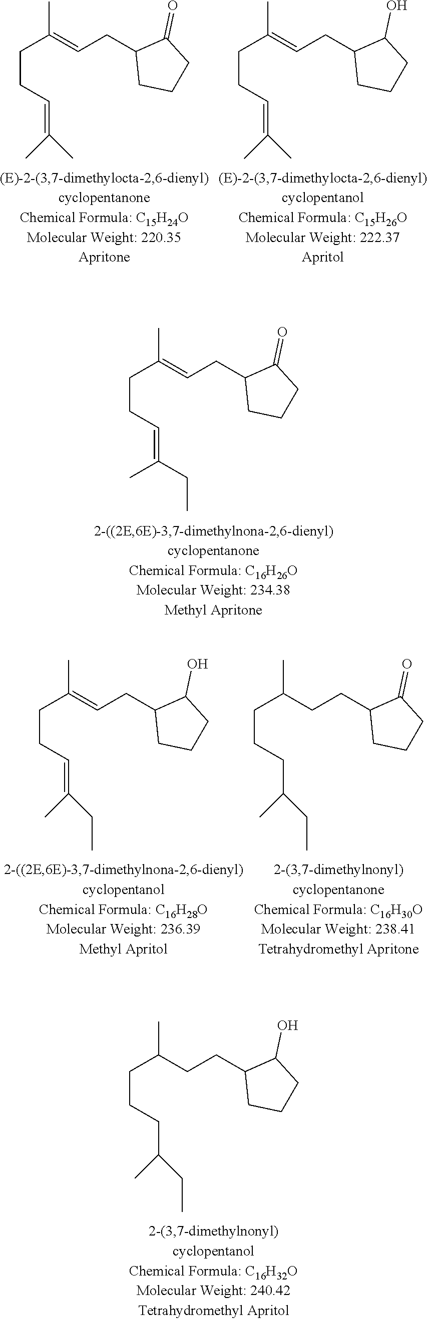 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O ; CCC(C)CCCC(C)CCC1CCCC1O]

32. The method according to clause 1 wherein the one or more compounds represented by structure (A) are selected from the group consisting of:

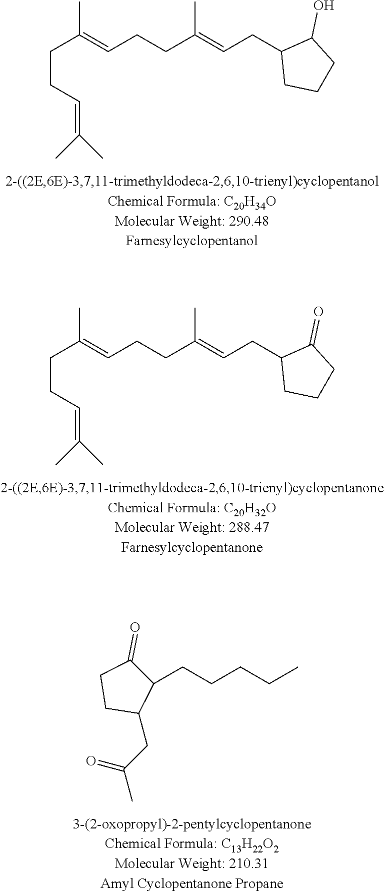 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O]

33. The method according to clause 1 wherein the one or more compounds represented by structure (A) are selected from the group consisting of:

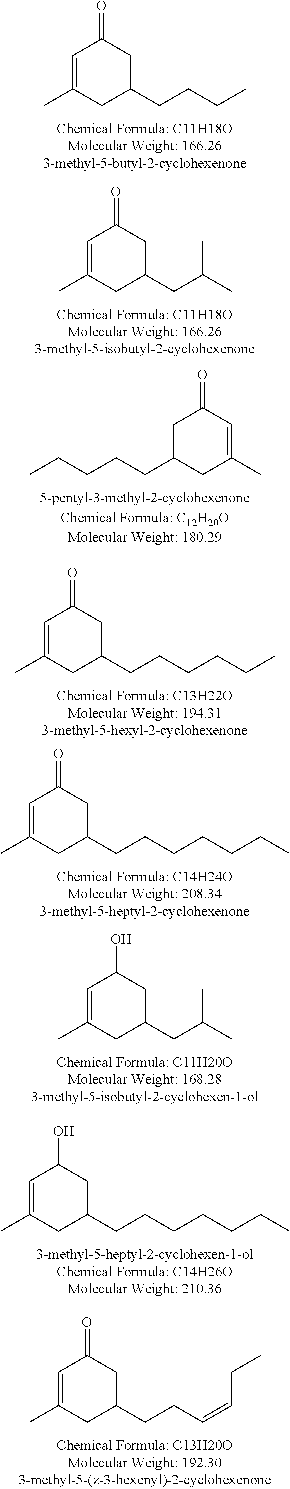

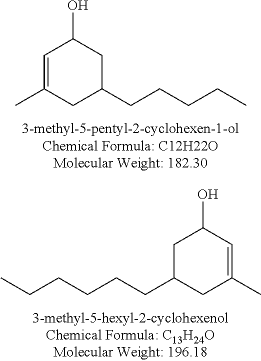

34. The method according to clause 1 wherein the one or more compounds represented by structure (A) are selected from the group consisting of:

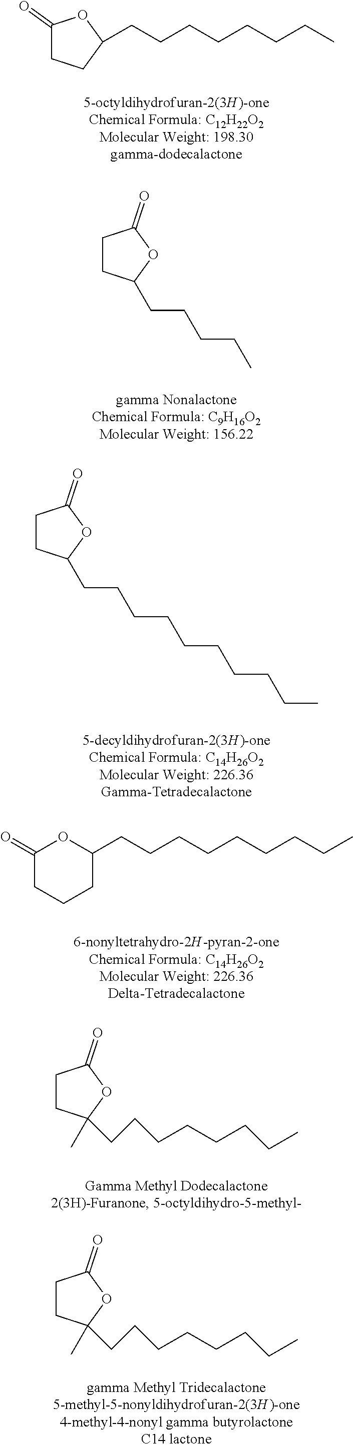 [SMILES: CCCCCCCCC1CCC(=O)O1 ; CCCCCC1CCC(=O)O1 ; CCCCCCCCCCC1CCC(=O)O1 ; CCCCCCCCCC1CCCC(=O)O1 ; CCCCCCCCC1(C)CCC(=O)O1 ; CCCCCCCCC1(C)CCC(=O)O1]

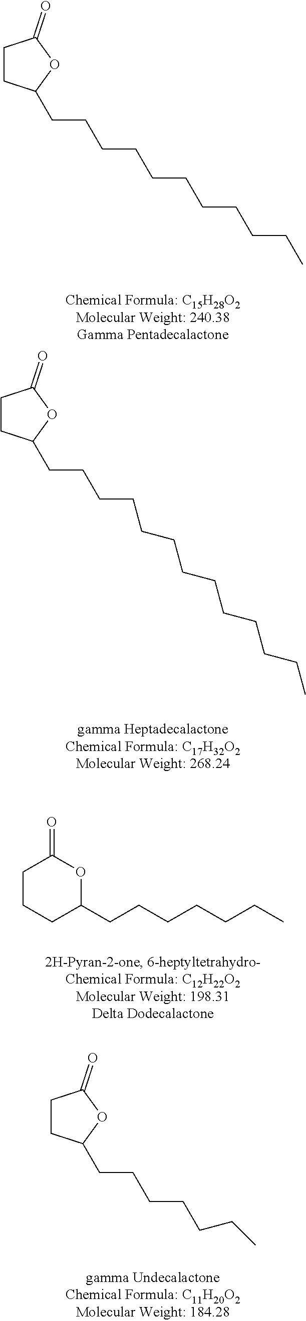 [SMILES: CCCCCCCCCCCC1CCC(=O)O1 ; CCCCCCCCCCCCCC1CCC(=O)O1 ; CCCCCCCC1CCCC(=O)O1 ; CCCCCCCC1CCC(=O)O1]

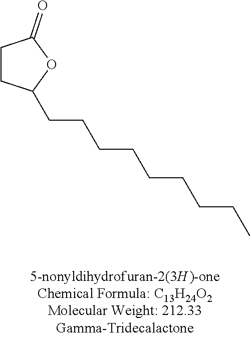

35. The method according to clause 1 wherein the one or more compounds represented by structure (A) are selected from the group consisting of methyl jasmonate, methyl dihydrojasmonate, methyl dihydrojasmolate (methyl 2-(3-hydroxy-2-pentylcyclopentyl)acetate), ethyl dihydrojasmonate, and propyl dihydrojasmonate.

36. The method according to clause 1 wherein the one or more compounds represented by structure (A) are selected from the group consisting of apritone (cyclopentanone, 2-(3,7-dimethyl-2,6-octadienyl)-), and methyl apritone (cyclopentanone, 2-(3,7-dimethyl-2,6-nonadien-1-yl)-).

37. The method according to clause 1 wherein the one or more compounds represented by structure (A) are selected from the group consisting of delta-dodecalactone, gamma-dodecalactone, gamma-undecalactone, gamma methyl dodecalactone, gamma-tridecalactone, gamma methyl tridecalactone, and gamma-tetradecalactone.

38. The method according to clause 1 wherein the one or more compounds represented by structure (A) are selected from the group consisting of 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, and 3-methyl-5-heptyl-2-cyclohexenone.

39. The method of clause 1, wherein the one or more compounds represented by structure (A) comprises methyl dihydrojasmonate (MDJ); wherein MDJ has a cis-:trans-enantiomer ratio from about 10:90 to about 90:10, or from about 15:85 to about 85:15, or from about 25:75 to about 75:25, or from about 30:70 to about 70:30, or from about 40:60 to about 60:40, or about 50:50.

40. The method of clause 1, wherein the one or more biostimulants are selected from the group consisting of acids, extracts, microbials, and assorted substances.

41. The method of clause 40, wherein the acids are selected from the group consisting of fulvic acids, amino acids, fatty acids/lipids, humic substances, humins, other organic acids, and B vitamins.

42. The method of clause 40, wherein the extracts are selected from the group consisting of peptides, polyamines, seaweed/kelp, betaines, carboxyls, laminarin, alginates, other polysaccharides, polyphenols, botanicals, allelochemicals, other organic matter extracts, chitin/chitosan, and phytohormones.

43. The method of clause 40, wherein the microbials are selected from the group consisting of rhizobium, complex communities/consortia, cytokinins, plant growth-promoting rhizobacteria (PGPR's), Mycorrhizae, Trichoderma, and other fungi.

44. The method of clause 40, wherein the assorted substances are selected from the group consisting of inorganic salts, proteins, phosphites, nitrogeneous compounds, enzymatic extracts, protein hydrolysates, elements including silicon, sodium, and cobalt.

45. The method of clause 1 wherein the one or more biostimulants are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

46. The method of clause 1, wherein the composition further comprises one or more fertilizers.

47. The method of clause 46 wherein the one or more fertilizers comprise chemical fertilizers selected from the group consisting of nitrate fertilizers, phosphate fertilizers, potash fertilizers, and mixed nitrogen:phosphorus:potassium (N:P:K) fertilizers.

48. The method of clause 1 wherein the one or more fertilizers comprise plant or seed nutrients essential for plant or seed growth; wherein the plant or seed nutrients comprise primary plant or seed nutrients selected from the group consisting of nitrogen, phosphorus, and potassium; secondary plant or seed nutrients selected from the group consisting of calcium, magnesium, and sulfur; and micronutrients selected from the group consisting of boron, copper, iron, manganese, molybdenum, zinc, and chlorine.

49. The method of clause 46 wherein the one or more fertilizers are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

50. The method of clause 1 wherein the one or more biostimulants and the one or more fertilizers are present in the composition in a weight ratio of the one or more biostimulants to the one or more fertilizers of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

51. The method according to clause 1 wherein the composition further comprises at least one adjuvant or additive selected from a group consisting of a carrier, wetting agents, adjuvants, emulsifiers, dispersants, spreaders, stickers, pastes, anchorage agents, fixatives, extenders, coating agents, buffering agents, pH adjusters, absorptive additives, disintegrants, and combinations thereof.

52. The method according to clause 1 wherein the composition comprises a liquid medium, wherein the liquid medium comprises the one or more compounds represented by the structure (A).

53. The method according to clause 52 wherein the liquid medium includes a surfactant.

54. The method according to clause 52 wherein the surfactant is an ionic, non-ionic, or zwitterionic surfactant.

55. The method according to clause 52 wherein the liquid medium includes an alcohol.

56. The method according to clause 52 wherein the liquid medium includes an oil.

57. The method according to clause 52 wherein the liquid medium includes a fixative selected from the group consisting of canola oil, castor oil, benzoyl benzoate, benzyl salicylate, synthetic musk, sandalwood, camauba wax, carob gum, dextrin, dextrose, gellan gum, guar gum, paraffin wax, sorbitol, xanthan gum, polyvinylpyrrolidone, and glycerin.

58. The method according to clause 52 wherein the liquid medium includes an absorptive additive selected from the group consisting of silica gel; precipitated crystalline-free silica gel; amorphous, fumed, crystalline-free silica; amorphous, precipitated gel silica; silica hydrate; vitreous silica; silicic acid; and silicon dioxide.

59. The method according to clause 1 wherein the composition is applied to the plant or seed by a method selected from a group consisting of foliar application, soil application, seed treatment, injection onto plant tissues, and combinations thereof.

60. The method according to clause 1 wherein the method comprises applying the composition to the plant or seed by foliar application, said foliar application comprises applying the composition at a rate of 50-1000 ml/acre of crop such that the amount of the one or more compounds represented by structure (A) applied is about 0.125 g/m² to about 150 g/m².

61. The method according to clause 1 wherein the composition is applied to plant seeds, to germinating seedling roots before they are planted, or to roots of existing plants.

62. The method according to clause 1 wherein the composition is applied onto the seeds and plants after harvest and at storage.

63. The method according to clause 1 wherein the composition is applied in situ, in the course of transfer, or introduced onto the bases of target plants.

64. The method according to clause 1 wherein the composition is applied to plants or seeds to induce tolerance in the plants or seeds to biotic and abiotic stresses.

65. The method according to clause 1 wherein the composition is applied to plants or seeds to induce tolerance in the plants or seeds to biotic stresses caused by bacteria, fungus, oomycetes, viruses, or insects.

66. The method according to clause 1 wherein the composition is applied to plants or seeds to induce tolerance in the plants or seeds to abotic stresses caused by low temperature/cold stress, freezing stress, high temperature/heat stress, salt/salinity stress, low light (shading stress), excessive light, ultraviolet (UV) radiation, other cosmic radiation, oxidative stress, heavy metal stress, lack of oxygen conditions, flooding, drought/water deficit, and/or a combination thereof

67. The method according to clause 1 wherein application of the composition to target plants or seeds results in localized or systemic biotic or abiotic stress tolerance throughout the plant or seed.

68. The method according to clause 1 wherein application of the composition to target plants or seeds results in localized or systemic biotic or abiotic stress tolerance throughout the plant or seed during growth season or post-harvest.

69. The method according to clause 1 wherein the protective response in the seed improves seed germination and seedling growth by altering seed vigor and/or the physiological state of the seed.

70. A method of inducing tolerance in a plant or seed to an environmental stress; and supporting one or more natural plant or seed processes, or supporting plant or seed nutrition, or a combination thereof; said method comprising applying to at least a portion of said plant or seed a composition comprising:
i) one or more compounds represented by structure (A):

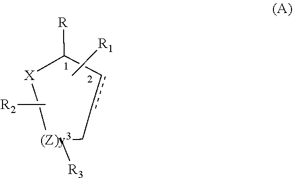

wherein R, X, Z, y, R₁, R₂, and R₃ are as defined in clause 1;
wherein the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds represented by structure (A); and
ii) one or more biostimulants, or one or more fertilizers, or a combination thereof;
wherein the one or more compounds represented by structure (A) are present in the composition in an effective amount sufficient to induce tolerance in the plant or seed to the environmental stress; and, when present, the one or more biostimulants are present in the composition in an amount sufficient to support one or more natural plant or seed processes; and, when present, the one or more fertilizers are present in the composition in an amount sufficient to support plant or seed nutrition.

71. An environmental stress-tolerant plant or seed produced by the method of clause 1.

72. A composition for protecting a plant or seed from stress injury resulting from an environmental stress; and supporting one or more natural plant or seed processes, or supporting plant or seed nutrition, or a combination thereof; said composition comprising:
i) one or more compounds represented by structure (A):

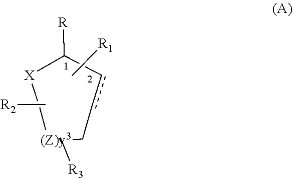

wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is 0 or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds represented by structure (A) are present in the composition in a protective amount sufficient to elicit a protective response in the plant or seed to the environmental stress; and, when present, the one or more biostimulants are present in the composition in an amount sufficient to support one or more natural plant or seed processes; and, when present, the one or more fertilizers are present in the composition in an amount sufficient to support plant or seed nutrition.

73. The composition of clause 72 wherein the one or more compounds represented by structure (A) are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

74. The composition of clause 72 wherein the environmental stress is a biotic stress or an abiotic stress.

75. The composition of clause 74 wherein the biotic stress is induced by a living organism selected from the group consisting of a virus, bacteria, fungi, viroid, phytoplasma, nematode, insect, pathogen, arachnid, and weed.

76. The composition of clause 74 wherein the abiotic stress is selected from the group consisting of desiccation, salt, drought, osmotic, temperature, wind, water, light, heavy metals, cold, heat, ozone, ultraviolet (UV) radiation, and nutrient deficiency.

77. The composition of clause 72 wherein the stress injury comprises plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, and/or reduced seedling vigor.

78. The composition of clause 72 wherein the plant or seed is selected from the group consisting of food crops, forage crops, fiber crops, oil crops, ornamental crops, and industrial crops.

79. The composition of clause 78 wherein the food crops are selected from the group consisting of cereals, fruits, vegetables, and spices.

80. The composition of clause 79 wherein the cereals are selected from the group consisting of wheat, rice, barley, millet, oats, rye, maize, sorghum; the fruits are selected from the group consisting of apples, pears, citrus, stone fruits, tropical fruits, exotic fruits, and berries; the vegetables are selected from the group consisting of root vegetables including beets, carrots, sweet potatoes, turnips; tubers: potatoes, yams; stem vegetables including asparagus, kohlrabi, celery; leafy green vegetables including lettuce, spinach, and silverbeet; allium or bulb vegetables including garlic, leeks, onions, and shallots; head or flower vegetables including artichokes, cabbage, and cauliflower; cucumber family vegetables including pumpkin, cucumber, and zucchini; and spices including pepper, ginger, spice seeds, and herbs.

81. The composition of clause 78 wherein the forage crops are selected from the group consisting of sorghum, alfalfa, barley, oats, millet, soybeans, wheat, maize, hay, and silage.

82. The composition of clause 78 wherein the fiber crops are selected from the group consisting of cotton, hemp, jute, kenaf, and flax.

83. The composition of clause 78 wherein the oil crops are selected from the group consisting of soybeans, sunflower seeds, rapeseed, canola, carmelina, palm, and peanuts.

84. The composition of clause 78 wherein the ornamental crops are selected from the group consisting of ivy, oleander, holly, tulips, roses, and azaleas.

85. The composition of clause 78 wherein the industrial crops are selected from the group consisting of cotton, jute, sugarcane, sugarbeet, coffee, tea, tobacco, coconut, and soybeans.

86. The composition of clause 78 wherein the seeds are selected from the group consisting of cereals, nuts, legumes, and spices.

87. The composition of clause 72 wherein the plant is a root, a stem, a leaf, a seed, a flower, or part thereof.

88. The composition of clause 72 wherein the plant is a dicot, monocot, annual, perennial, crop plant, alfalfa, rice, wheat, barley, rye, cotton, sunflower, peanut, corn, oat, millet, flax, potato, sweet potato, bean, green bean, wax bean, lima bean, pea, chicory, lettuce, endive, cabbage, brussel sprout, beet, sugar beet, parsnip, turnip, cauliflower, broccoli, turnip, radish, spinach, onion, garlic, eggplant, pepper, celery, carrot, squash, pumpkin, zucchini, cucumber, melon, yam, carrots, cassava, citrus, strawberry, grape, raspberry, pineapple, soybean, tobacco, tomato, sorghum, sugarcane, ornamental plant, Arabidopsis thaliana, Saintpaulia, Petunia, Pelargonium, Poinsettia, Chrysanthemum, carnation, Zinnia, poplar, apple, pear, peach, cherry, almond, plum, hazelnuts, banana, apricot, grape, kiwi, mango, melon, papaya, walnut, pistachio, raspberry, blackberry, loganberry, blueberry, cranberry, orange, lemon, grapefruit, tangerine, avocado, or cocoa.

89. The composition of clause 72 wherein the one or more compounds represented by structure (A) comprise a compound wherein R is ═O or —OH, X is CH₂, Z is (CH) or (CH₂), y is 1, the bond between positions 2 and 3 is a single bond, R₁ is H, R₂ is H, and R₃ is an alkenyl group having at least 11 carbon atoms and 1 or 2 double bonds.

90. The composition of clause 72 wherein the one or more compounds represented by structure (A) comprise a compound wherein R is ═O or —OH, X is CH₂, Z is (CH) or (CH₂), y is 1, the bond between positions 2 and 3 is a single bond, R₁ is an alkyl group having at least 5 carbon atoms, R₂ is H, and R₃ is —C(O)OR₅, and R₅ is an alkyl or alkenyl group containing at least 3 carbon atoms.

91. The composition of clause 72 wherein the one or more compounds represented by structure (A) comprise a compound wherein R is ═O, X is O, Z is CH or CH₂, y is 1 or 2, the bond between positions 2 and 3 is a single bond, R₁ is an alkyl group of from 7 to 11 carbon atoms, R₂ is H, and R₃ is H or CH₃.

92. The composition of clause 72 wherein the one or more compounds represented by structure (A) are selected from the group consisting of:

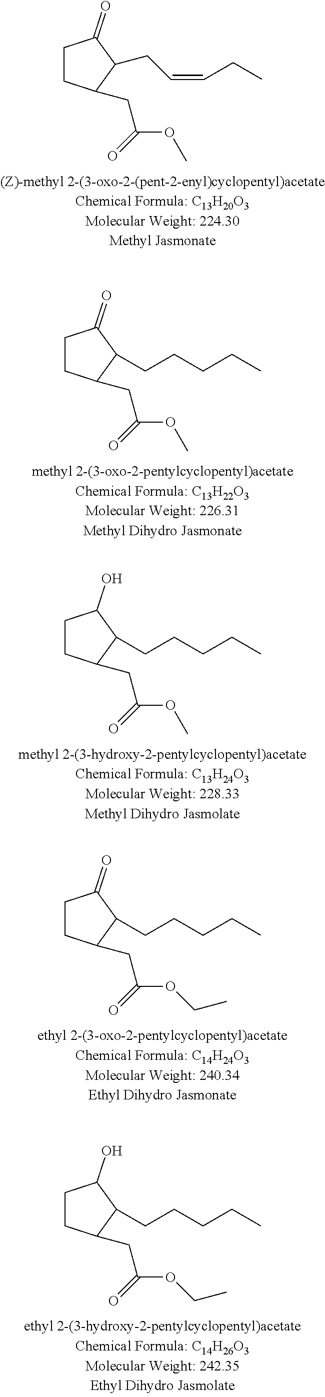 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC]

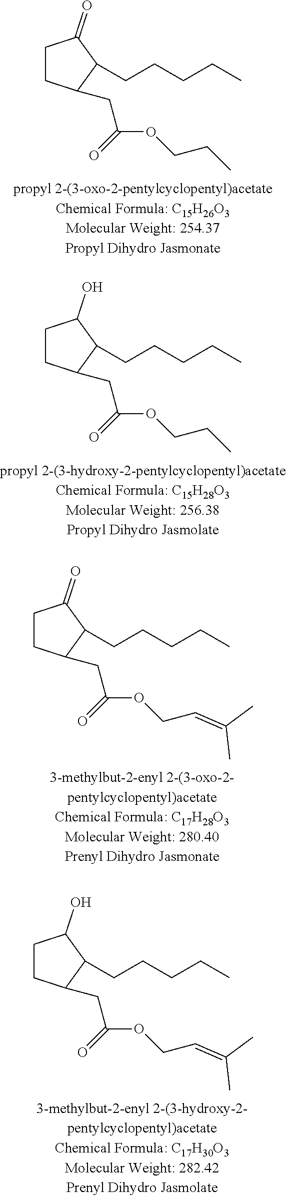 [SMILES: CCCCCC1C(=O)CCC1CC(=O)OCCC ; CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C]

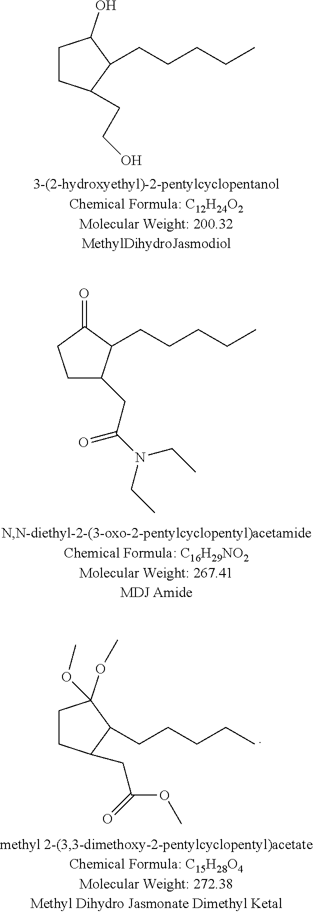 [SMILES: CCCCCC1C(O)CCC1CCO ; CCCCCC1C(=O)CCC1CC(=O)N(CC)CC ; CCCCCC1C(CC(=O)OC)CCC1(OC)OC]

93. The composition of clause 72 wherein the one or more compounds represented by structure (A) are selected from the group consisting of:

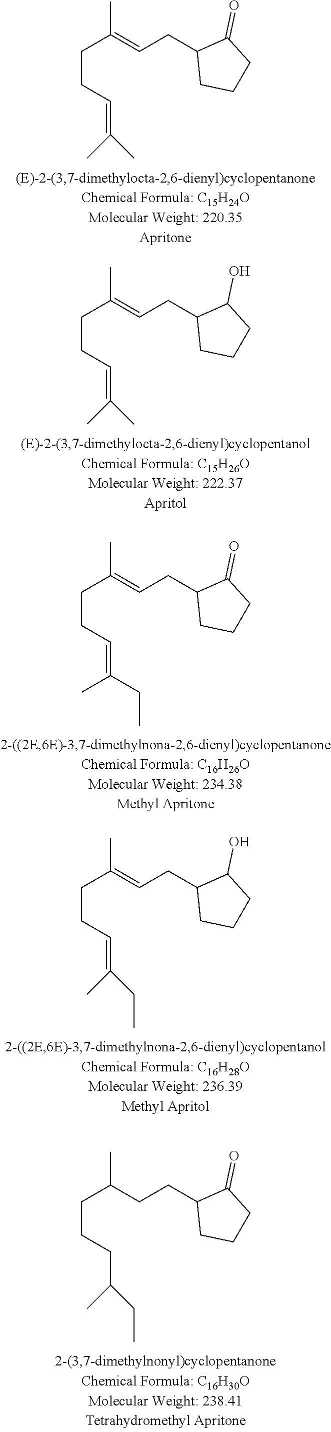 [SMILES: CC(C)=CCC/C(C)=C/CC1CCCC1=O ; CC(C)=CCC/C(C)=C/CC1CCCC1O ; CC/C(C)=C/CC/C(C)=C/CC1CCCC1=O ; CC/C(C)=C/CC/C(C)=C/CC1CCCC1O ; CCC(C)CCCC(C)CCC1CCCC1=O]

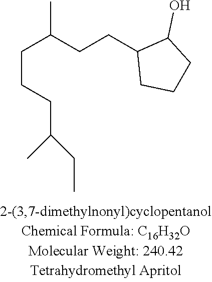 [SMILES: CCC(C)CCCC(C)CCC1CCCC1O]

94. The composition of clause 72 wherein the one or more compounds represented by structure (A) are selected from the group consisting of:

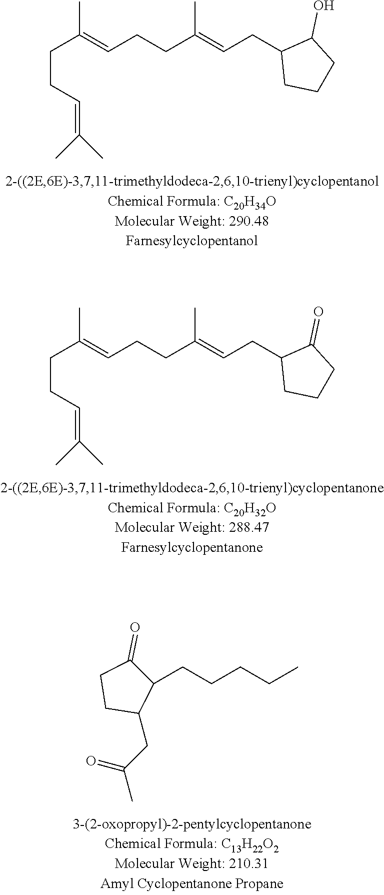 [SMILES: CC(C)=CCC/C(C)=C/CC/C(C)=C/CC1CCCC1O ; CC(C)=CCC/C(C)=C/CC/C(C)=C/CC1CCCC1=O ; CCCCCC1C(=O)CCC1CC(C)=O]

95. The composition of clause 72 wherein the one or more compounds represented by structure (A) are selected from the group consisting of:

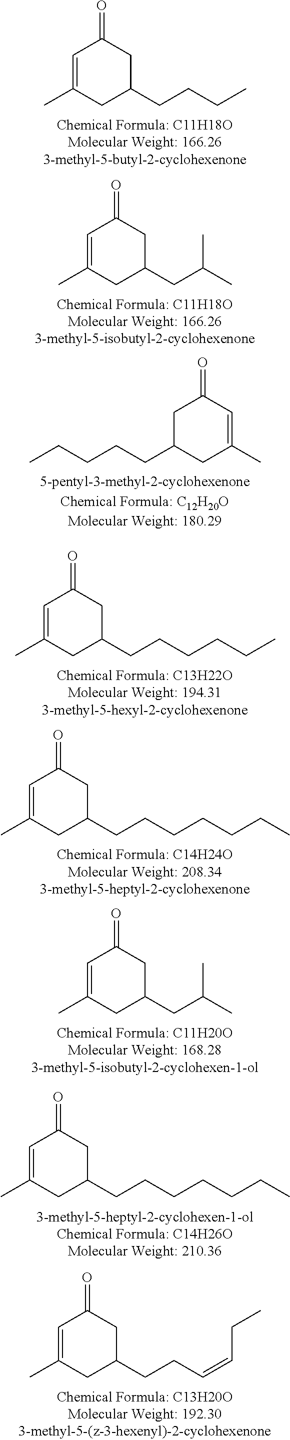

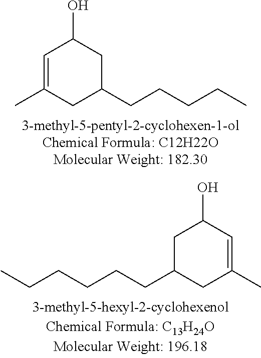

96. The composition of clause 72 wherein the one or more compounds represented by structure (A) are selected from the group consisting of:

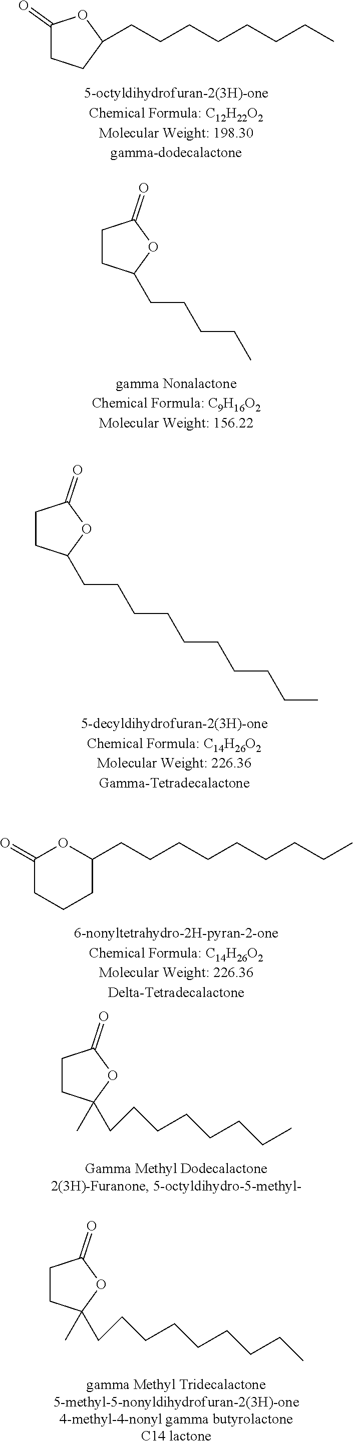 [SMILES: CCCCCCCCC1CCC(=O)O1 ; CCCCCC1CCC(=O)O1 ; CCCCCCCCCCC1CCC(=O)O1 ; CCCCCCCCCC1CCCC(=O)O1 ; CCCCCCCCC1(C)CCC(=O)O1 ; CCCCCCCCCC1(C)CCC(=O)O1]

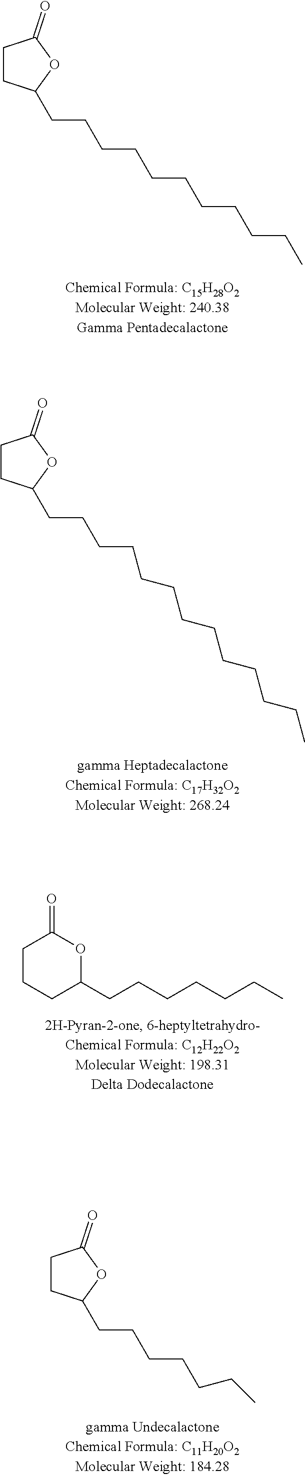 [SMILES: CCCCCCCCCCCC1CCC(=O)O1 ; CCCCCCCCCCCCCC1CCC(=O)O1 ; CCCCCCCC1CCCC(=O)O1 ; CCCCCCCC1CCC(=O)O1]

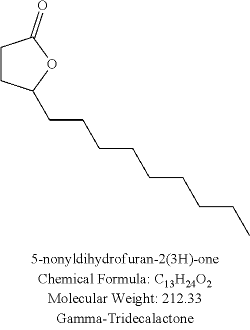

97. The composition of clause 72 wherein the one or more compounds represented by structure (A) are selected from the group consisting of methyl jasmonate, methyl dihydrojasmonate, methyl dihydrojasmolate (methyl 2-(3-hydroxy-2-pentylcyclopentyl)acetate), ethyl dihydrojasmonate, and propyl dihydrojasmonate.

98. The composition of clause 72 wherein the one or more compounds represented by structure (A) are selected from the group consisting of apritone (cyclopentanone, 2-(3,7-dimethyl-2,6-octadienyl)-), and methyl apritone (cyclopentanone, 2-(3,7-dimethyl-2,6-nonadien-1-yl)-).

99. The composition of clause 72 wherein the one or more compounds represented by structure (A) are selected from the group consisting of delta-dodecalactone, gamma-dodecalactone, gamma-undecalactone, gamma methyl dodecalactone, gamma-tridecalactone, gamma methyl tridecalactone, and gamma-tetradecalactone.

100. The composition of clause 72 wherein the one or more compounds represented by structure (A) are selected from the group consisting of 3-methyl-5-propyl-2-cyclohexenone, 3-methyl-5-butyl-2-cyclohexenone, 3-methyl-5-pentyl-2-cyclohexenone, 3-methyl-5-hexyl-2-cyclohexenone, and 3-methyl-5-heptyl-2-cyclohexenone.

101. The composition of clause 72 further comprising at least one adjuvant or additive selected from a group consisting of a carrier, wetting agents, adjuvants, emulsifiers, dispersants, spreaders, stickers, pastes, anchorage agents, fixatives, extenders, coating agents, buffering agents, pH adjusters, absorptive additives, disintegrants, and combinations thereof.

102. The composition of clause 72 further comprising a liquid medium, wherein the liquid medium comprises the one or more compounds represented by the structure (A).

103. The composition of clause 102 wherein the liquid medium includes a surfactant.

104. The composition of clause 103 wherein the surfactant is an ionic, non-ionic, or zwitterionic surfactant.

105. The composition of clause 102 wherein the liquid medium includes an alcohol.

106. The composition of clause 72 wherein the liquid medium includes an oil.

107. The composition of clause 102 wherein the liquid medium includes a fixative selected from the group consisting of canola oil, castor oil, benzoyl benzoate, benzyl salicylate, synthetic musk, sandalwood, camauba wax, carob gum, dextrin, dextrose, gellan gum, guar gum, paraffin wax, sorbitol, xanthan gum, polyvinylpyrrolidone, and glycerin.

108. The composition of clause 72 wherein the liquid medium includes an absorptive additive selected from the group consisting of silica gel; precipitated crystalline-free silica gel; amorphous, fumed, crystalline-free silica; amorphous, precipitated gel silica; silica hydrate; vitreous silica; silicic acid; and silicon dioxide.

109. The composition of clause 72 which is applied to the plant or seed by a method selected from a group consisting of foliar application, soil application, seed treatment, injection onto plant tissues, and combinations thereof.

110. The composition of clause 72 which is applied to the plant or seed by foliar application, said foliar application comprises applying the composition at a rate of 50-1000 ml/acre of crop such that the amount of the one or more compounds represented by structure (A) applied is about 0.125 g/m² to about 150 g/m².

111. The composition of clause 72 which is applied to plant seeds, to germinating seedling roots before they are planted, or to roots of existing plants.

112. The composition of clause 72 which is applied onto the seeds and plants after harvest and at storage.

113. The composition of clause 72 which is applied in situ, in the course of transfer, or introduced onto the bases of target plants.

114. The composition of clause 72 which is applied to plants or seeds to induce tolerance in the plants or seeds to biotic and abiotic stresses.

115. The composition of clause 72 which is applied to plants or seeds to induce tolerance in the plants or seeds to biotic stresses caused by bacteria, fungus, oomycetes, viruses, or insects.

116. The composition of clause 72 which is applied to plants or seeds to induce tolerance in the plants or seeds to abotic stresses caused by low temperature/cold stress, freezing stress, high temperature/heat stress, salt/salinity stress, low light (shading stress), excessive light, ultraviolet (UV) radiation, other cosmic radiation, oxidative stress, heavy metal stress, lack of oxygen conditions, flooding, drought/water deficit, and/or a combination thereof.

117. The composition of clause 72 wherein application of the composition to target plants or seeds results in localized or systemic biotic or abiotic stress tolerance throughout the plant or seed.

118. The composition of clause 72 wherein application of the composition to target plants or seeds results in localized or systemic biotic or abiotic stress tolerance throughout the plant or seed during growth season or post-harvest.

119. The composition of clause 72 wherein the protective response in the seed improves seed germination and seedling growth by altering seed vigor and/or the physiological state of the seed.

120. A composition for inducing tolerance in a plant or seed to an environmental stress; and supporting one or more natural plant or seed processes, or supporting plant or seed nutrition, or a combination thereof; said composition comprising:
i) one or more compounds represented by structure (A):

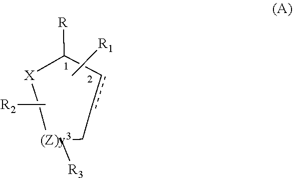

wherein R, X, Z, y, R₁, R₂, and R₃ are as defined in clause 51;
wherein the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds represented by structure (A) are present in the composition in an effective amount sufficient to induce tolerance in the plant or seed to the environmental stress; and, when present, the one or more biostimulants are present in the composition in an amount sufficient to support one or more natural plant or seed processes; and, when present, the one or more fertilizers are present in the composition in an amount sufficient to support plant or seed nutrition.

121. An environmental stress-tolerant plant or seed treated with the composition of clause 72.

122. A method of protecting a plant or seed from stress injury resulting from an environmental stress; and supporting one or more natural plant or seed processes, or supporting plant or seed nutrition, or a combination thereof; said method comprising applying to at least a portion of said plant or seed a synergistic composition comprising:
i) a synergistic combination of one or more compounds represented by structure (A):

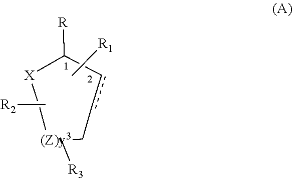

wherein R, X, Z, y, R₁, R₂, and R₃ are as defined in clause 1;
wherein the bond between the 2 and 3 positions in the ring structure may be a single or a double bond;
wherein the one or more compounds of structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds of structure (A) are present in the synergistic composition in a protective amount sufficient to elicit a protective response in the plant or seed to the environmental stress; and, when present, the one or more biostimulants are present in the synergistic composition in an amount sufficient to support one or more natural plant or seed processes; and, when present, the one or more fertilizers are present in the synergistic composition in an amount sufficient to support plant or seed nutrition;
wherein the synergistic combination comprising a combination of one or more compounds of structure (A); and one or more biostimulants, or one or more fertilizers, or a combination thereof; produces, when the plant or seed is treated with the synergistic composition, a combined protection or supporting effect, greater than the sum of the separate protection or supporting effects, at essentially the same concentrations.

123. A synergistic composition for protecting a plant or seed from stress injury resulting from an environmental stress; and supporting one or more natural plant or seed processes, or supporting plant or seed nutrition, or a combination thereof; said synergistic composition comprising:
i) a synergistic combination of one or more compounds represented by structure (A):

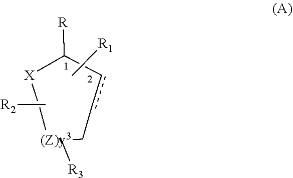

wherein R, X, Z, y, R₁, R₂, and R₃ are as defined in clause 51;
wherein the bond between the 2 and 3 positions in the ring structure may be a single or a double bond;
wherein the one or more compounds of structure (A) contain from about 9 to about 20 carbon atoms, and includes optical isomers, diastereomers and enantiomers of the one or more compounds of structure (A); and
ii) one or more biostimulants, or one or more fertilizers, or a combination thereof:
wherein the one or more compounds of structure (A) are present in the synergistic composition in a protective amount sufficient to elicit a protective response in the plant or seed to the environmental stress; and, when present, the one or more biostimulants are present in the synergistic composition in an amount sufficient to support one or more natural plant or seed processes; and, when present, the one or more fertilizers are present in the synergistic composition in an amount sufficient to support plant or seed nutrition;
wherein the synergistic combination comprising a combination of one or more compounds of structure (A); and one or more biostimulants, or one or more fertilizers, or a combination thereof; produces, when the plant or seed is treated with the synergistic composition, a combined protection or supporting effect, greater than the sum of the separate protection or supporting effects, at essentially the same concentrations.

124. A method for inducing tolerance in a plant or seed to an environmental stress; and supporting one or more natural plant or seed processes, or supporting plant or seed nutrition, or a combination thereof; said method comprising applying to at least a portion of said plant or seed a synergistic composition comprising:
i) a synergistic combination of one or more compounds represented by structure (A):

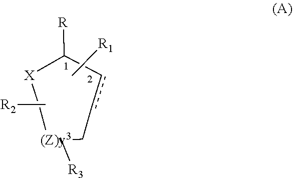

wherein R, X, Z, y, R₁, R₂, and R₃ are as defined in clause 1;
wherein the bond between the 2 and 3 positions in the ring structure may be a single or a double bond;
wherein the one or more compounds of structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds of structure (A) are present in the synergistic composition in an effective amount sufficient to induce tolerance in the plant or seed to the environmental stress; and, when present, the one or more biostimulants are present in the synergistic composition in an amount sufficient to support one or more natural plant or seed processes; and, when present, the one or more fertilizers are present in the synergistic composition in an amount sufficient to support plant or seed nutrition;
wherein the synergistic combination comprising a combination of one or more compounds of structure (A); and one or more biostimulants, or one or more fertilizers, or a combination thereof; produces, when the plant or seed is treated with the synergistic composition, a combined protection or supporting effect, greater than the sum of the separate protection or supporting effects, at essentially the same concentrations.

125. A synergistic composition for inducing tolerance in a plant or seed to an environmental stress; and supporting one or more natural plant or seed processes, or supporting plant or seed nutrition, or a combination thereof; said synergistic composition comprising:
i) a synergistic combination of one or more compounds represented by structure (A):

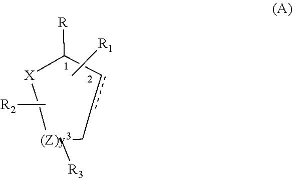

wherein R, X, Z, y, R₁, R₂, and R₃ are as defined in clause 51;
wherein the bond between the 2 and 3 positions in the ring structure may be a single or a double bond;
wherein the one or more compounds of structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds of structure (A) are present in the synergistic composition in an effective amount sufficient to induce tolerance in the plant or seed to the environmental stress; and, when present, the one or more biostimulants are present in the synergistic composition in an amount sufficient to support one or more natural plant or seed processes; and, when present, the one or more fertilizers are present in the synergistic composition in an amount sufficient to support plant or seed nutrition;
wherein the synergistic combination comprising a combination of one or more compounds of structure (A); and one or more biostimulants, or one or more fertilizers, or a combination thereof; produces, when the plant or seed is treated with the synergistic composition, a combined protection or supporting effect, greater than the sum of the separate protection or supporting effects, at essentially the same concentrations.

126. The synergistic composition of clause 123, wherein the protection effect is reduced application rate, widening of the activity spectrum, increase in the activity of the substances and compositions to be used, better plant and seed growth, increased tolerance to high or low temperatures, increased tolerance to drought or to water or soil salt content, increased flowering performance, easier harvesting, accelerated maturation, higher harvest yields, better quality of the harvested products, higher nutritional value of the harvested products, better storage stability of the harvested products, or processability of the harvested products.

127. The synergistic composition of clause 125, wherein the induced tolerance is increased tolerance to high or low temperatures, or increased tolerance to drought or to water or soil salt content.

128. A method of seed treatment; and supporting one or more natural plant or seed processes, or supporting plant or seed nutrition, or a combination thereof; said method comprising applying to at least a portion of said seed a composition comprising:
i) one or more compounds represented by structure (A):

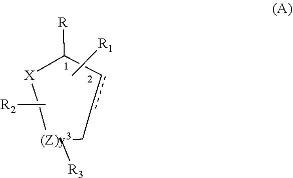

wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is 0 or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds represented by structure (A); and
ii) one or more biostimulants, or one or more fertilizers, or a combination thereof;
wherein the one or more compounds represented by structure (A) are present in the composition in an effective amount sufficient to improve a germination characteristic of the seed, as compared to the same germination characteristic of an untreated seed; and, when present, the one or more biostimulants are present in the composition in an amount sufficient to support one or more natural plant or seed processes; and, when present, the one or more fertilizers are present in the composition in an amount sufficient to support plant or seed nutrition.

129. The method of clause 128, wherein the germination characteristic of the seed is germination rate, rate of development, vigor, or yield of mature plants originating from the seed.

130. A seed treated by the method of clause 128.

131. A method of seed treatment; and supporting one or more natural plant or seed processes, or supporting plant or seed nutrition, or a combination thereof; said method comprising applying to at least a portion of said seed a synergistic composition comprising:
i) a synergistic combination of one or more compounds represented by structure (A):

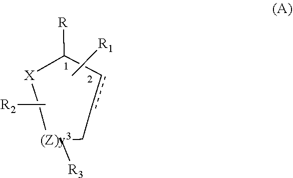

wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is 0 or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds of structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds of structure (A) are present in the synergistic composition in an amount sufficient to effect a germination characteristic of the seed; and, when present, the one or more biostimulants are present in the synergistic composition in an amount sufficient to support one or more natural plant or seed processes; and, when present, the one or more fertilizers are present in the synergistic composition in an amount sufficient to support plant or seed nutrition;
wherein the synergistic combination comprising a combination of one or more compounds of structure (A); and one or more biostimulants, or one or more fertilizers, or a combination thereof; produces, when the seed is treated with the synergistic composition, a combined germination characteristic effect or supporting effect, greater than the sum of the separate germination characteristic effects or supporting effects, at essentially the same concentrations.

132. The method of clause 131, wherein the germination characteristic of the seed is germination rate, rate of development, vigor, or yield of mature plants originating from the seed.

133. A seed treated by the method of clause 131.

134. A synergistic composition for improving a germination characteristic of a seed; and supporting one or more natural plant or seed processes, or supporting plant or seed nutrition, or a combination thereof; said synergistic composition comprising:
i) a synergistic combination of one or more compounds represented by structure (A):

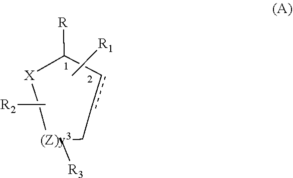

wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is 0 or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds of structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds of structure (A) are present in the synergistic composition in an amount sufficient to effect a germination characteristic of the seed; and, when present, the one or more biostimulants are present in the synergistic composition in an amount sufficient to support one or more natural plant or seed processes; and, when present, the one or more fertilizers are present in the synergistic composition in an amount sufficient to support plant or seed nutrition;
wherein the synergistic combination comprising a combination of one or more compounds of structure (A); and one or more biostimulants, or one or more fertilizers, or a combination thereof; produces, when the seed is treated with the synergistic composition, a combined germination characteristic effect or supporting effect, greater than the sum of the separate germination characteristic effects or supporting effects, at essentially the same concentrations.

135. The synergistic composition of clause 134, wherein the germination characteristic of the seed is germination rate, rate of development, vigor, or yield of mature plants originating from the seed.

136. A seed treated by the synergistic composition of clause 134.

As used herein, the term “about” is defined as plus or minus ten percent of a recited value. For example, about 1.0 g means 0.9 g to 1.1 g. Alternatively, depending on context, the term “about” can be defined as plus or minus of up to fifty percent of a recited value. For example, about 1.0 g means up to between 0.5 g to 1.5 g.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

Embodiments of the present disclosure are shown and described herein. It will be apparent to those skilled in the art that such embodiments are provided by way of example only. Numerous variations, changes, and substitutions will occur to those skilled in the art without departing from the disclosure. Various alternatives to the embodiments of the disclosure described herein may be employed in practicing the disclosure. It is intended that the included claims define the scope of the disclosure and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

What is claimed is:

1. A method of protecting a plant or seed from stress injury resulting from an environmental stress; and supporting one or more natural plant or seed processes, or supporting plant or seed nutrition, or a combination thereof; said method comprising applying to at least a portion of said plant or seed a composition comprising:
i) one or more compounds represented by structure (A): 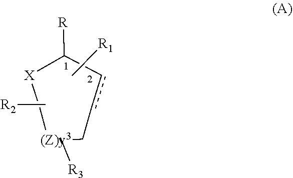
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is 0 or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds represented by structure (A); and
ii) one or more biostimulants, or one or more fertilizers, or a combination thereof;
wherein the one or more compounds represented by structure (A) are present in the composition in a protective amount sufficient to elicit a protective response in the plant or seed to the environmental stress; and, when present, the one or more biostimulants are present in the composition in an amount sufficient to support one or more natural plant or seed processes; and, when present, the one or more fertilizers are present in the composition in an amount sufficient to support plant or seed nutrition.

2. The method of claim 1 wherein the one or more compounds represented by structure (A) are present in the composition in an amount from about 0.00001% by weight to about 50% by weight, or in an amount from about 0.0001% by weight to about 40% by weight, or in an amount from about 0.0010% by weight to about 30% by weight, based on the total weight of the composition.

3. The method of claim 1 wherein the one or more biostimulants are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

4. The method of claim 1 wherein the one or more fertilizers are present in the composition in an amount from about 0.00001% by weight to about 50% by weight, or in an amount from about 0.0001% by weight to about 40% by weight, or in an amount from about 0.001% by weight to about 30% by weight, based on the total weight of the composition.

5. The method of claim 1 wherein the one or more compounds represented by structure (A) and the one or more biostimulants are present in the composition in a weight ratio of the one or more compounds represented by structure (A) to the one or more biostimulants of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

6. The method of claim 1 wherein the one or more compounds represented by structure (A) and the one or more fertilizers are present in the composition in a weight ratio of the one or more compounds represented by structure (A) to the one or more fertilizers of from about 99.9:0.1 to about 0.1:99.9, or from about 90:10 to about 10:90, or from about 80:20 to about 20:80, or from about 70:30 to about 30:70, or from about 60:40 to about 40:60, or about 50:50.

7. The method of claim 1 wherein the environmental stress is a biotic stress or an abiotic stress.

8. The method of claim 7 wherein the biotic stress is induced by a living organism selected from the group consisting of a virus, bacteria, fungi, viroid, phytoplasma, nematode, insect, pathogen, arachnid, and weed.

9. The method of claim 7 wherein the abiotic stress is selected from the group consisting of desiccation, salt, drought, osmotic, temperature, wind, water, light, heavy metals, cold, heat, ozone, ultraviolet (UV) radiation, and nutrient deficiency.

10. The method of claim 1 wherein the stress injury comprises plant death, leaf yellowing, leaf death, no shoot meristem growth, poor shoot meristem growth, plant wilting, loss or degradation of chlorophyll in leaves, leaf browning, leaf wilting or curling, destruction of chloroplasts, leaf lesions, seed death, retarded seed germination, no seed germination, retarded growth (root and shoot) seedlings, no growth (root and shoot) seedlings, retarded rate of seed germination, lower root and shoot fresh weight, and/or reduced seedling vigor.

11. The method of claim 1 wherein the natural plant or seed processes are selected from the group consisting of photosynthesis, respiration, growth, transpiration, and nutrient uptake.

12. The method of claim 1 wherein the natural plant or seed processes are supported to enhance at least one of nutrient uptake, nutrient efficiency, abiotic stress tolerance, crop quality, and crop yield.

13. The method of claim 1 wherein plant or seed nutrition is supported to enhance plant or seed growth.

14. The method of claim 1 wherein plant or seed nutrition is supported by chemical fertilizers selected from the group consisting of nitrate fertilizers, phosphate fertilizers, potash fertilizers, and mixed nitrogen:phosphorus:potassium (N:P:K) fertilizers.

15. The method of claim 1 wherein plant or seed nutrition is supported by plant or seed nutrients essential for plant or seed growth, including primary plant or seed nutrients selected from the group consisting of nitrogen, phosphorus, and potassium; secondary plant or seed nutrients selected from the group consisting of calcium, magnesium, and sulfur; and micronutrients selected from the group consisting of boron, copper, iron, manganese, molybdenum, zinc, and chlorine.

16. The method of claim 1 wherein the plant or seed is selected from the group consisting of food crops, forage crops, fiber crops, oil crops, ornamental crops, and industrial crops.

17. The method of claim 16 wherein the food crops are selected from the group consisting of cereals, fruits, vegetables, and spices; the forage crops are selected from the group consisting of sorghum, alfalfa, barley, oats, millet, soybeans, wheat, maize, hay, and silage; the fiber crops are selected from the group consisting of cotton, hemp, jute, kenaf, and flax; the oil crops are selected from the group consisting of soybeans, sunflower seeds, rapeseed, canola, carmelina, palm, and peanuts; the ornamental crops are selected from the group consisting of ivy, oleander, holly, tulips, roses, and azaleas; and the industrial crops are selected from the group consisting of cotton, jute, sugarcane, sugarbeet, coffee, tea, tobacco, coconut, and soybeans.

18. The method of claim 16 wherein the seeds are selected from the group consisting of cereals, nuts, legumes, and spices.

19. The method according to claim 1 wherein the one or more compounds represented by structure (A) are selected from the group consisting of:

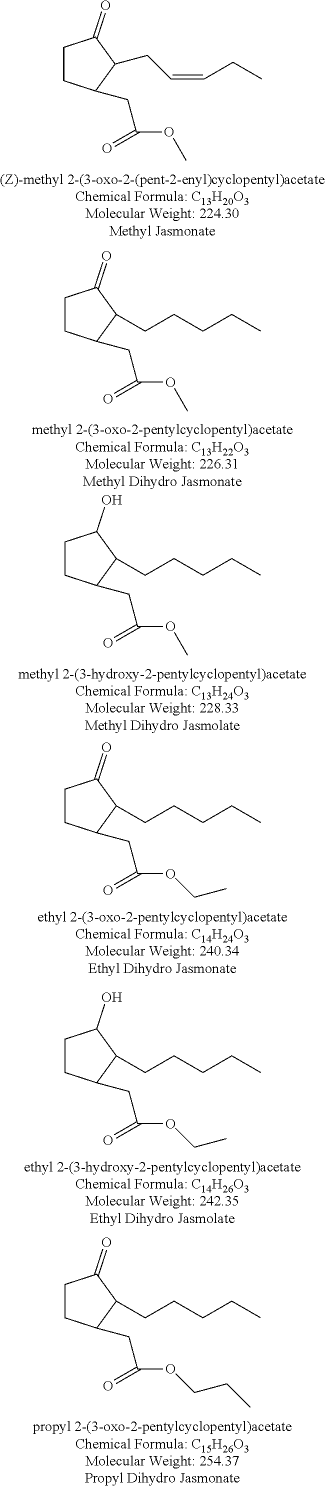 [SMILES: CC/C=C\CC1C(=O)CCC1CC(=O)OC ; CCCCCC1C(=O)CCC1CC(=O)OC ; CCCCCC1C(O)CCC1CC(=O)OC ; CCCCCC1C(=O)CCC1CC(=O)OCC ; CCCCCC1C(O)CCC1CC(=O)OCC ; CCCCCC1C(=O)CCC1CC(=O)OCCC]

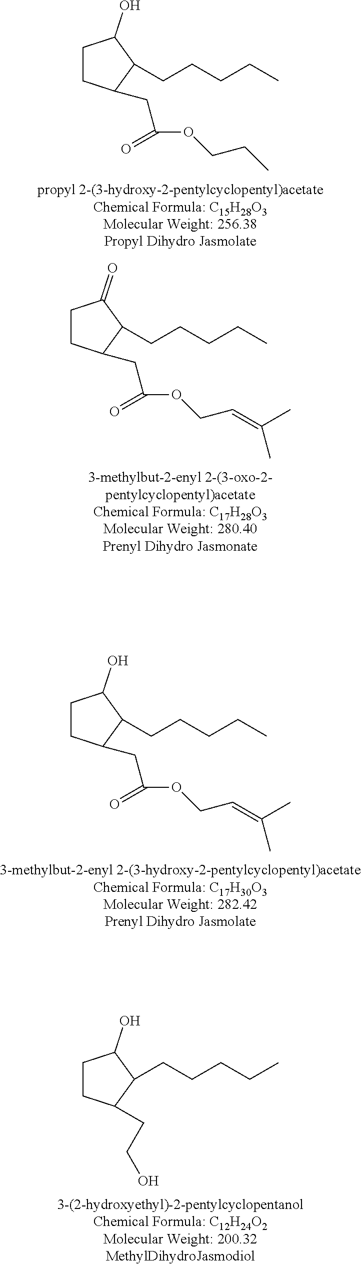 [SMILES: CCCCCC1C(O)CCC1CC(=O)OCCC ; CCCCCC1C(=O)CCC1CC(=O)OCC=C(C)C ; CCCCCC1C(O)CCC1CC(=O)OCC=C(C)C ; CCCCCC1C(O)CCC1CCO]

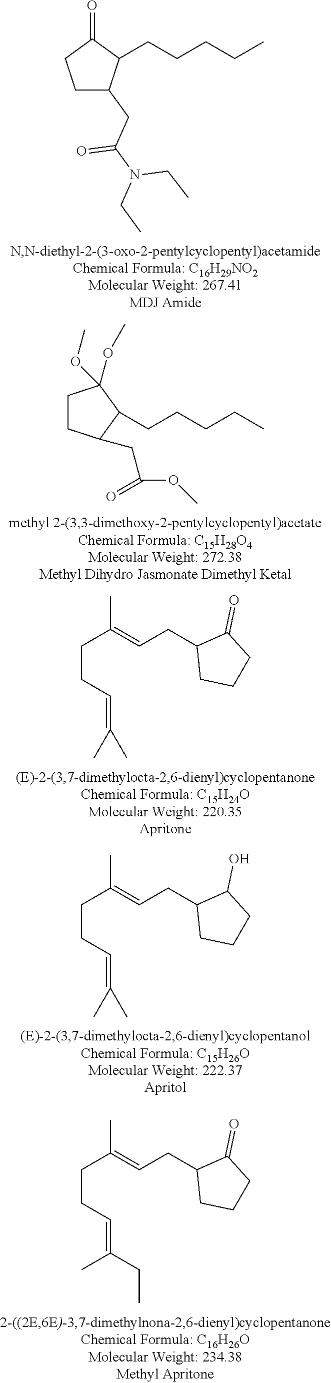 [SMILES: CCCCCC1C(=O)CCC1CC(=O)N(CC)CC ; CCCCCC1C(CC(=O)OC)CCC1(OC)OC ; CC(C)=CCC/C(C)=C/CC1CCCC1=O ; CC(C)=CCC/C(C)=C/CC1CCCC1O ; CC/C(C)=C/CC/C(C)=C/CC1CCCC1=O]

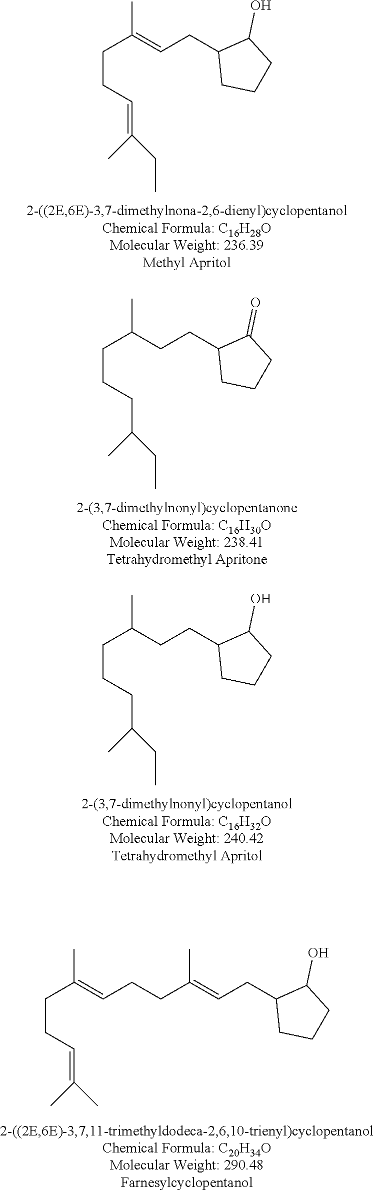 [SMILES: CC/C(C)=C/CC/C(C)=C/CC1CCCC1O ; CCC(C)CCCC(C)CCC1CCCC1=O ; CCC(C)CCCC(C)CCC1CCCC1O ; CC(C)=CCC/C(C)=C/CC/C(C)=C/CC1CCCC1O]

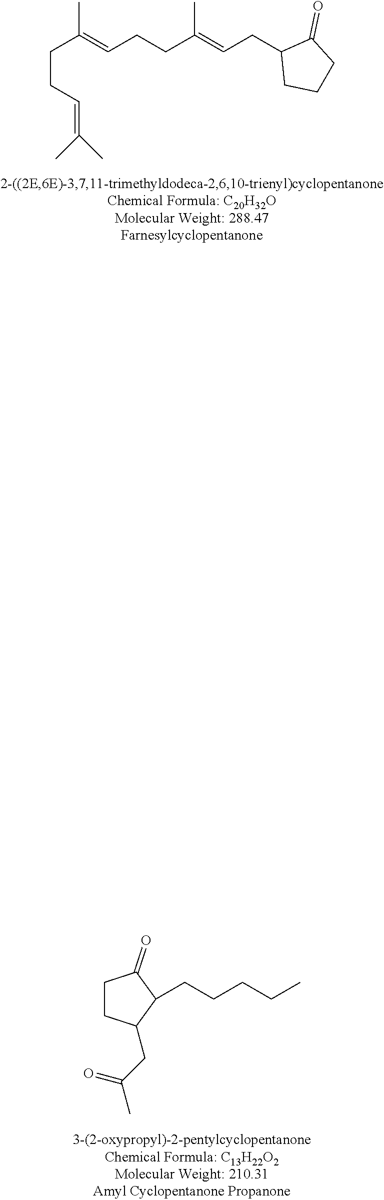 [SMILES: CC(C)=CCC/C(C)=C/CC/C(C)=C/CC1CCCC1=O ; CCCCCC1C(=O)CCC1CC(C)=O]

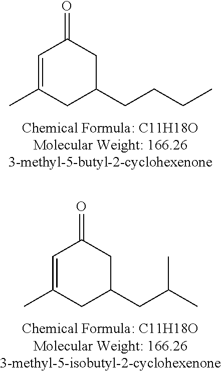

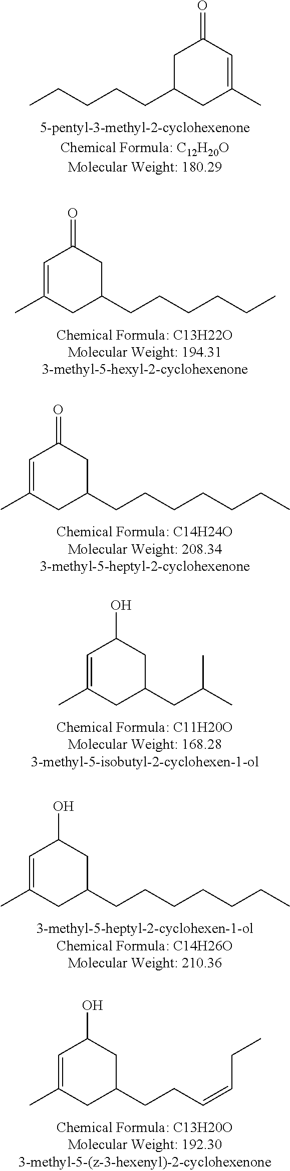

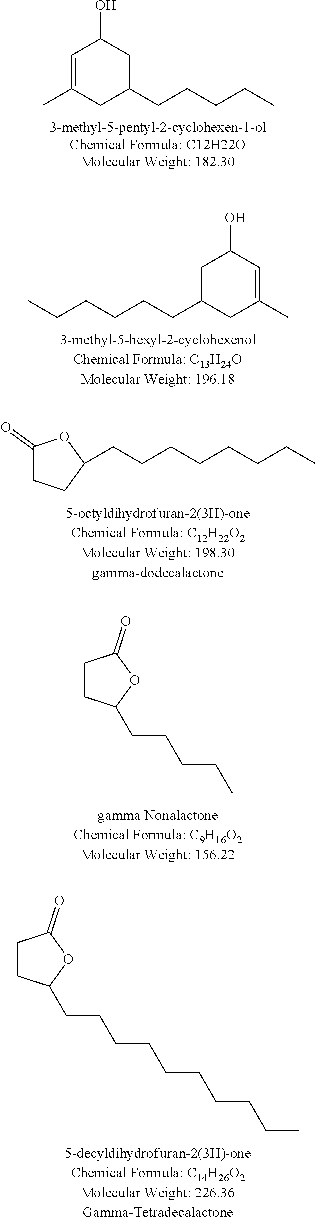

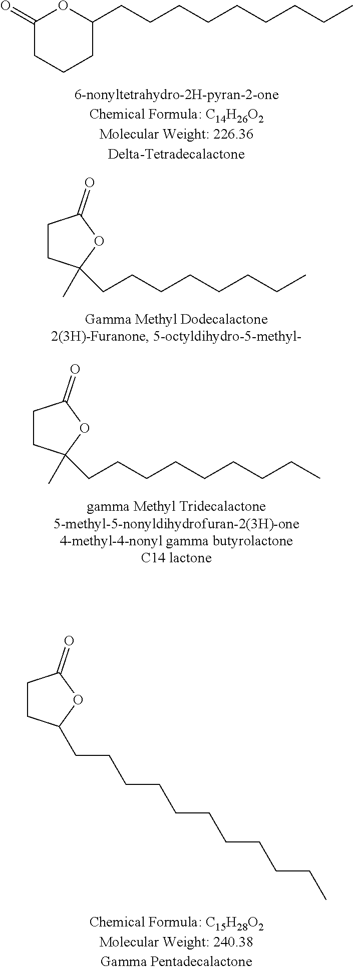 [SMILES: CCCCCCCCCC1CCCC(=O)O1 ; CCCCCCCCC1(C)CCC(=O)O1 ; CCCCCCCCCC1(C)CCC(=O)O1 ; CCCCCCCCCCCC1CCC(=O)O1]

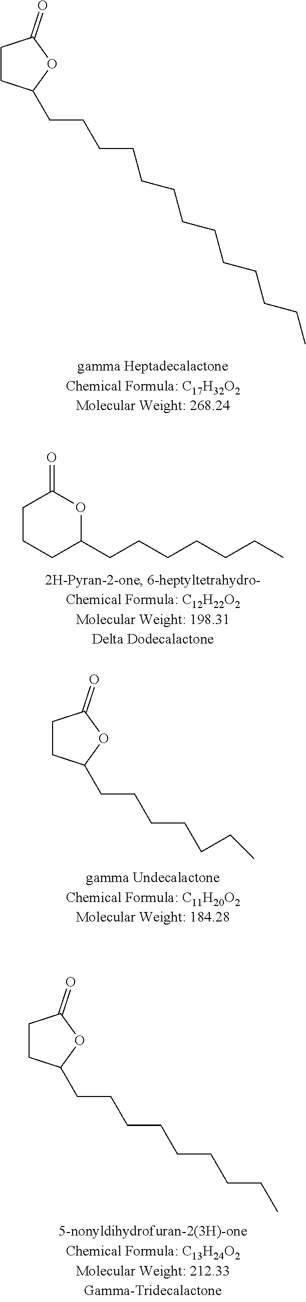 [SMILES: CCCCCCCCCCCCCC1CCC(=O)O1 ; CCCCCCCC1CCCC(=O)O1 ; CCCCCCCC1CCC(=O)O1 ; CCCCCCCCCC1CCC(=O)O1]

20. The method of claim 1, wherein the one or more compounds represented by structure (A) comprises methyl dihydrojasmonate (MDJ); wherein MDJ has a cis-trans-enantiomer ratio from about 10:90 to about 90:10, or from about 15:85 to about 85:15, or from about 25:75 to about 75:25, or from about 30:70 to about 70:30, or from about 40:60 to about 60:40, or about 50:50.

21. The method of claim 1, wherein the one or more biostimulants are selected from the group consisting of acids, extracts, microbials, and assorted substances.

22. The method of claim 21, wherein the acids are selected from the group consisting of fulvic acids, amino acids, fatty acids/lipids, humic substances, humins, other organic acids, and B vitamins.

23. The method of claim 21, wherein the extracts are selected from the group consisting of peptides, polyamines, seaweed/kelp, betaines, carboxyls, laminarin, alginates, other polysaccharides, polyphenols, botanicals, allelochemicals, other organic matter extracts, chitin/chitosan, and phytohormones.

24. The method of claim 21, wherein the microbials are selected from the group consisting of rhizobium, complex communities/consortia, cytokinins, plant growth-promoting rhizobacteria (PGPR's), Mycorrhizae, Trichoderma, and other fungi.

25. The method of claim 21, wherein the assorted substances are selected from the group consisting of inorganic salts, proteins, phosphites, nitrogeneous compounds, enzymatic extracts, protein hydrolysates, elements including silicon, sodium, and cobalt.

26. The method of claim 1, wherein the composition further comprises one or more fertilizers.

27. The method of claim 26 wherein the one or more fertilizers comprise chemical fertilizers selected from the group consisting of nitrate fertilizers, phosphate fertilizers, potash fertilizers, and mixed nitrogen:phosphorus:potassium (N:P:K) fertilizers.

28. The method of claim 1 wherein the one or more fertilizers comprise plant or seed nutrients essential for plant or seed growth; wherein the plant or seed nutrients comprise primary plant or seed nutrients selected from the group consisting of nitrogen, phosphorus, and potassium; secondary plant or seed nutrients selected from the group consisting of calcium, magnesium, and sulfur; and micronutrients selected from the group consisting of boron, copper, iron, manganese, molybdenum, zinc, and chlorine.

29. The method of claim 1 wherein the composition further comprises at least one adjuvant or additive selected from a group consisting of a carrier, wetting agents, adjuvants, emulsifiers, dispersants, spreaders, stickers, pastes, anchorage agents, fixatives, extenders, coating agents, buffering agents, pH adjusters, absorptive additives, disintegrants, and combinations thereof.

30. The method of claim 1 wherein the composition comprises a liquid medium, wherein the liquid medium comprises the one or more compounds represented by the structure (A); and one or more biostimulants, or one or more fertilizers, or a combinations thereof; optionally a surfactant, optionally an alcohol, optionally an oil, optionally a fixative selected from the group consisting of canola oil, castor oil, benzoyl benzoate, benzyl salicylate, synthetic musk, sandalwood, camauba wax, carob gum, dextrin, dextrose, gellan gum, guar gum, paraffin wax, sorbitol, xanthan gum, polyvinylpyrrolidone, and glycerin; and optionally an absorptive additive selected from the group consisting of silica gel; precipitated crystalline-free silica gel; amorphous, fumed, crystalline-free silica; amorphous, precipitated gel silica; silica hydrate; vitreous silica; silicic acid; and silicon dioxide.

31. The method of claim 1, wherein the composition is applied to the plant or seed by a method selected from a group consisting of foliar application, soil application, seed treatment, injection onto plant tissues, and combinations thereof

32. The method of claim 1, wherein the composition is applied to plant seeds, to germinating seedling roots before they are planted, or to roots of existing plants, or to seeds and plants after harvest and at storage, or is applied in situ, in the course of transfer, or introduced onto the bases of target plants.

33. The method of claim 1 wherein the composition is applied to plants or seeds to induce tolerance in the plants or seeds to biotic and abiotic stresses, or is applied to plants or seeds to induce tolerance in the plants or seeds to biotic stresses caused by bacteria, fungus, oomycetes, viruses, or insects, or is applied to plants or seeds to induce tolerance in the plants or seeds to abotic stresses caused by low temperature/cold stress, freezing stress, high temperature/heat stress, salt/salinity stress, low light (shading stress), excessive light, ultraviolet (UV) radiation, other cosmic radiation, oxidative stress, heavy metal stress, lack of oxygen conditions, flooding, drought/water deficit, and/or a combination thereof.

34. The method of claim 1, wherein application of the composition to target plants or seeds results in localized or systemic biotic or abiotic stress tolerance throughout the plant or seed, or results in localized or systemic biotic or abiotic stress tolerance throughout the plant or seed during growth season or post-harvest.

35. The method of claim 1 wherein the protective response in the seed improves seed germination and seedling growth by altering seed vigor and/or the physiological state of the seed.

36. A composition for protecting a plant or seed from stress injury resulting from an environmental stress; and for supporting one or more natural plant or seed processes, or for supporting plant or seed nutrition, or a combination thereof; said composition comprising:
i) one or more compounds represented by structure (A): 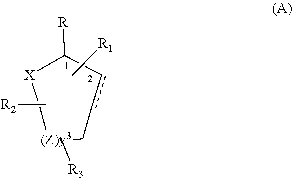
wherein:
R is selected from —OH, ═O, —OC(O)R₄, —OR₆, and —(OR₆)₂, wherein each R₆ is independently selected from an alkyl group containing from about 1 to about 4 carbon atoms and R₄ is a branched or straight chain, saturated or unsaturated, hydrocarbyl group with zero to two double bonds and from about 1 to about 15 carbon atoms;
X is 0 or CH₂, with the proviso that when X is O, R can only be ═O;
each Z is independently selected from (CH) and (CH₂);
y is a numeral selected from 1 and 2;
R₁ is selected from H or a branched or straight chain, saturated or unsaturated, hydrocarbyl group with zero to two double bonds and from about 1 to about 15 carbon atoms;
R₂ is selected from H and a branched or straight chain, saturated or unsaturated, hydrocarbyl group with zero to three double bonds and from about 1 to about 15 carbon atoms;
R₃ is selected from H, a branched or straight chain, saturated or unsaturated, hydrocarbyl group with zero to three double bonds and from about 1 to about 15 carbon atoms, —(CH₂)ₙOH, —C(O)OR₅, —CH₂C(O)OR₇, —CH₂C(O)R₈, —C(O)NR₉R₁₀, and —CH₂C(O)NR₁₁R₁₂, wherein each of R₅, R₇, R₈, R₉, R₁₀, R₁₁ and R₁₂ is independently selected from H and a branched or straight chain, saturated or unsaturated, hydrocarbyl group with zero to three double bonds and from about 1 to about 15 carbon atoms, and n is n integer of from 1 to 12;
the bond between the 2 and 3 positions in the ring structure may be a single or a double bond;
wherein the one or more compounds represented by structure (A) contain from about 9 to about 20 carbon atoms, and includes optical isomers, diastereomers and enantiomers of the one or more compounds of structure (A); and
ii) one or more biostimulants, or one or more fertilizers, or a combination thereof;
wherein the one or more compounds represented by structure (A) are present in the composition in a protective amount sufficient to elicit a protective response in the plant or seed to the environmental stress, and when present, the one or more biostimulants are present in the composition in an amount sufficient to support one or more natural plant or seed processes; and the one or more fertilizers are present in the composition in an amount sufficient to support plant or seed nutrition.

37. A method of inducing tolerance in a plant or seed to an environmental stress; and supporting one or more natural plant or seed processes, or for supporting plant or seed nutrition, or a combination thereof; said method comprising applying to at least a portion of said plant or seed a composition of claim 36.

38. An environmental stress-tolerant plant or seed produced by the method of claim 1.

39. An environmental stress-tolerant plant or seed treated with the composition of claim 36.

40. A method of protecting a plant or seed from stress injury resulting from an environmental stress; and supporting one or more natural plant or seed processes, or for supporting plant or seed nutrition, or a combination thereof; said method comprising applying to at least a portion of said plant or seed a synergistic composition comprising a synergistic combination of one or more compounds represented by structure (A); and one or more biostimulants, or one or more fertilizers, or a combination thereof; in claim 36.

41. A method of seed treatment, said method comprising applying to at least a portion of said seed a composition of claim 36.

42. A seed treated by the method of claim 41.
